(19) United States
(12) Patent Application Publication
(10) Pub. No.: US 2024/0248209 A1
(43) Pub. Date: Jul. 25, 2024

(54) TARGET DETECTION METHOD AND DEVICE BASED ON LASER SCANNING

(71) Applicant: WUHAN VANJEE OPTOELECTRONIC TECHNOLOGY CO., LTD., Wuhan (CN)

(72) Inventors: Yongqiang DENG, Beijing (CN); Yang XU, Beijing (CN); Yi HUANG, Beijing (CN); Ximing DAI, Beijing (CN)

(21) Appl. No.: 18/425,687

(22) Filed: Jan. 29, 2024

Related U.S. Application Data
(63) Continuation-in-part of application No. PCT/CN2022/109163, filed on Jul. 29, 2022.
(63) Continuation-in-part of application No. PCT/CN2022/108322, filed on Jul. 27, 2022.
(63) Continuation-in-part of application No. PCT/CN2022/106313, filed on Jul. 18, 2022.
(63) Continuation-in-part of application No. PCT/CN2022/107246, filed on Jul. 22, 2022.

(30) Foreign Application Priority Data
Jul. 30, 2021 (CN) 202110876217.9
Jul. 30, 2021 (CN) 202110876227.2
Jul. 30, 2021 (CN) 202110876253.5
Jul. 30, 2021 (CN) 202110876256.9

(51) Int. Cl. G01S 17/42; G01S 17/89; G01S 17/931

(52) U.S. Cl. CPC G01S 17/42; G01S 17/89; G01S 17/931

(57) ABSTRACT

A target detection method includes: scanning a preset scanning area with a first scanning resolution to obtain a first point cloud in a first scanning cycle; performing target detection on the first point cloud; when a target is detected, determining a fine scanning area and an observation scanning area based on the target, the fine scanning area corresponding to a position of the target in the preset scanning area, and the observation scanning area being an area in the preset scanning area except the fine scanning area; and scanning the fine scanning area with a second scanning resolution and scanning the observation scanning area with a third scanning resolution, to obtain a second point cloud in a second scanning cycle; wherein the second scanning resolution is greater than the first scanning resolution, and the third scanning resolution is less than or equal to the first scanning resolution.

### CROSS-REFERENCE TO RELATED APPLICATIONS

The disclosure claims the benefits of priority to: PCT Application No. PCT/CN2022/109163, filed Jul. 29, 2022, which claims the benefits of priority to Chinese Application No. 202110876227.2, filed Jul. 30, 2021; PCT Application No. PCT/CN2022/108322, filed Jul. 27, 2022, which claims the benefits of priority to Chinese Application No. 202110876253.5, filed Jul. 30, 2021; PCT Application No. PCT/CN2022/106313, filed Jul. 18, 2022, which claims the benefits of priority to Chinese Application No. 202110876256.9, filed Jul. 30, 2021; and PCT Application No. PCT/CN2022/107246, filed Jul. 22, 2022, which claims the benefits of priority to Chinese Application No. 202110876217.9, filed Jul. 30, 2021. All of the above applications are incorporated herein by reference in their entireties.

### TECHNICAL FIELD

The present disclosure generally relates to laser scanning technology, and more particularly, to a target detection method, and a device, based on laser scanning.

### BACKGROUND

Laser scanning technology has the characteristics of accurate positioning and high efficiency and is often used in fields such as target positioning and tracking.

In related target positioning and tracking methods based on laser scanning technology, when the target is scanned within a larger scanning range, the target's position and motion trajectory are determined through precise scanning.

However, when the environment of the target may change, damage, disappearance or other circumstances may occur to the target, therefore, accuracy of positioning and accuracy of tracking are both reduced.

### SUMMARY OF THE DISCLOSURE

Embodiments of the present disclosure provide a target detection method based on laser scanning. The method includes: scanning a preset scanning area with a first scanning resolution to obtain a first point cloud in a first scanning cycle; performing target detection on the first point cloud; when a target is detected, determining a fine scanning area and an observation scanning area based on the target, the fine scanning area corresponding to a position of the target in the preset scanning area, and the observation scanning area being an area in the preset scanning area except the fine scanning area; and scanning the fine scanning area with a second scanning resolution and scanning the observation scanning area with a third scanning resolution, to obtain a second point cloud in a second scanning cycle; wherein the second scanning resolution is greater than the first scanning resolution, and the third scanning resolution is less than or equal to the first scanning resolution.

Embodiments of the present disclosure provide a target detection method based on laser scanning. The method includes: scanning a preset scanning area with a first scanning resolution to obtain a first point cloud; performing target detection on the first point cloud; when a target is detected, determining a fine scanning area and an observation scanning area based on the target, the fine scanning area corresponding to a position of the target in the preset scanning area and the observation scanning area being an area in the preset scanning area except the fine scanning area; and scanning the fine scanning area with a second scanning resolution and scanning the observation scanning area with a third scanning resolution, to obtain a second point cloud; wherein a number of point clouds per unit area in the fine scanning area when scanning with the second scanning resolution is larger than a number of point clouds per unit area in the preset scanning area when scanning with the first scanning resolution, and a number of point clouds per unit area in the observation scanning area when scanning with the third scanning resolution is smaller than the number of point clouds per unit area in the preset scanning area when scanning with the first scanning resolution.

Embodiments of the present disclosure provide a target detection device based on laser scanning. The target detection device includes: a laser scanning module configured to scan a preset scanning area with a first scanning resolution to obtain a first point cloud of a first scanning cycle; and a detection module configured to perform target detection on the first point cloud of the first scanning cycle, and determine a fine scanning area and an observation scanning area based on a target when the target is detected, the fine scanning area corresponding to a position of the target in the preset scanning area and the observation scanning area being an area in the preset scanning area except the fine scanning area; the laser scanning module is further configured to scan the fine scanning area with a second scanning resolution and scan the observation scanning area with a third scanning resolution, to obtain a second point cloud in a second scanning cycle, wherein the second scanning resolution is greater than the first scanning resolution, and the third scanning resolution is less than or equal to the first scanning resolution.

Embodiments of the present disclosure provide a target detection device based on laser scanning. The target detection device includes: an area scanning module configured to scan a preset scanning area with a first scanning resolution to obtain a first point cloud; and an area dividing module configured to perform target detection on the first point cloud, and determine a fine scanning area and an observation scanning area based on a target when the target is detected, the fine scanning area corresponding to a position of the target in the preset scanning area and the observation scanning area being an area in the preset scanning area except the fine scanning area; the area scanning module is further configured to scan the fine scanning area with a second scanning resolution and scan the observation scanning area with a third scanning resolution, to obtain a second point cloud, wherein a number of point clouds per unit area in the fine scanning area when scanning with the second scanning resolution is larger than a number of point clouds per unit area in the preset scanning area when scanning with the first scanning resolution, and a number of point clouds per unit area in the observation scanning area when scanning with the third scanning resolution is smaller than the number of point clouds per unit area in the preset scanning area when scanning with the first scanning resolution.

The target detection methods and devices provide by the present disclosure can realize target detection while determining changes in the surrounding environment of the targets in a preset scanning area, thus ensuring the safety of the targets and improving the accuracy of the target positioning.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 illustrates a schematic diagram of an exemplary target detection device based on laser scanning, according to some embodiments of the present disclosure.

FIG. 2 illustrates a flow chart of an exemplary target detection method based on laser scanning, according to some embodiments of the present disclosure.

FIG. 3 illustrates an exemplary application scenario diagram of scanning a preset scanning area with a first scanning resolution, according to some embodiments of the present disclosure.

FIG. 4 illustrates an exemplary application scenario diagram of the fine scanning area and the observation scanning area, according to some embodiments of the present disclosure.

FIG. 5 illustrates an exemplary application scenario diagram of scanning based on new targets, according to some embodiments of the present disclosure.

FIG. 6 illustrates a structural block diagram of an exemplary target detection device based on laser scanning, according to some embodiments of the present disclosure.

FIG. 7 illustrates a structural block diagram of an exemplary target detection terminal, according to some embodiments of the present disclosure.

FIG. 8 illustrates a flow chart of an exemplary sensing method for sensing system, according to some embodiments of the present disclosure.

FIG. 9 illustrates a flow chart of an exemplary method for controlling an Optical Phased Array (OPA) Light Detection and Ranging (LiDAR), according to some embodiments of the present disclosure.

FIG. 10 illustrates a structural block diagram of an exemplary sensing system, according to some embodiments of the present disclosure.

FIG. 11 illustrates a structural block diagram of an exemplary sensing system, according to some embodiments of the present disclosure.

FIG. 12 illustrates a structural block diagram of an exemplary control system of an OPA LiDAR, according to some embodiments of the present disclosure.

FIG. 13 illustrates a structural block diagram of an exemplary terminal device, according to some embodiments of the present disclosure.

FIG. 14 illustrates a schematic diagram of an exemplary OPA LiDAR, according to some embodiments of the present disclosure.

FIG. 15 illustrates a flow chart of an exemplary target detection method, according to some embodiments of the present disclosure.

FIG. 16 illustrates a schematic diagram of an exemplary light spot combination, according to some embodiments of the present disclosure.

FIG. 17 illustrates a schematic diagram of another exemplary light spot combination, according to some embodiments of the present disclosure.

FIG. 18 illustrates a schematic diagram of another exemplary light spot combination, according to some embodiments of the present disclosure.

FIG. 19 illustrates a schematic diagram of another exemplary light spot combination, according to some embodiments of the present disclosure.

FIG. 20 illustrates a flow chart of another target detection method, according to some embodiments of the present disclosure.

FIG. 21 illustrates a flow chart of another target detection method, according to some embodiments of the present disclosure.

FIG. 22 illustrates a flow chart of another target detection method, according to some embodiments of the present disclosure.

FIG. 23 illustrates a structural block diagram of an exemplary OPA LiDAR, according to some embodiments of the present disclosure.

FIG. 24 illustrates a structural block diagram of another exemplary OPA LiDAR, according to some embodiments of the present disclosure.

FIG. 25 illustrates a structural block diagram of another exemplary OPA LiDAR, according to some embodiments of the present disclosure.

FIG. 26 illustrates a flow chart of an exemplary method for identifying noisy points of an OPA LiDAR, according to some embodiments of the present disclosure.

FIG. 27A-FIG. 27D illustrate diagrams of an exemplary application scenario of the method for identifying noisy points, according to some embodiments of the present disclosure.

FIG. 28A-FIG. 28D illustrate diagrams of another exemplary application scenario of the method for identifying noisy points, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

The target detection method based on laser scanning provided by the embodiments of the present disclosure can be executed by a target detection terminal, which is equipped with an Optical Phased Array (OPA) Light Detection and Ranging (LiDAR) and is loaded with an application software for executing a program of the target detection method based on laser scanning. The target detection terminal can be a mobile terminal, a vehicle-mounted device, a computer and other terminal equipment, and the embodiments of the present application do not place any restrictions on the specific type of the terminal equipment.

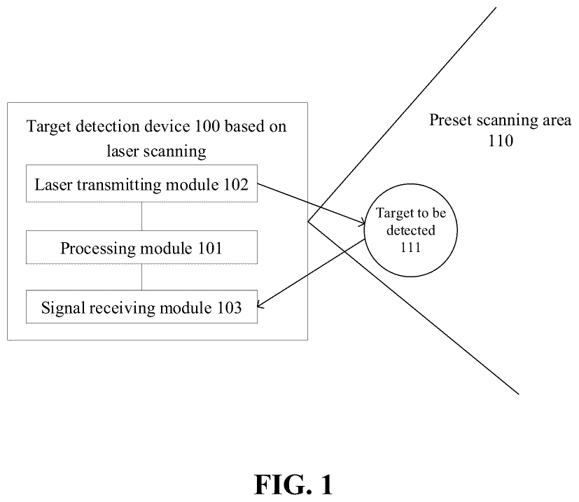

FIG. 1 illustrates a schematic diagram of an exemplary target detection device 100 based on laser scanning, according to some embodiments of the present disclosure. Target detection device 100 based on laser scanning includes a processing module 101, a laser transmitting module 102, and a signal receiving module 103. Processing module 101 is communicatively coupled with laser transmitting module 102 and signal receiving module 103, respectively. Laser transmitting module 102 is configured to transmit corresponding laser signals in a scanning area 110 according to the control instructions sent by processing module 101. Signal receiving module 103 is configured to receive the point cloud data reflected by a target 111 in scanning area 110 and provide the point cloud data to processing module 101. Processing module 101 is configured to control the laser signal parameters of laser transmitting module 102 (including but not limited to the resolution, frame rate and scanning area of the laser signals) through control instructions, receive the point cloud data returned by signal receiving module 103, and adjust the parameters of the laser signals and updates the control instructions based on the aforesaid point cloud data. Processing module 101 may include a processor, such as CPU (Central Processing Unit), MCU (Micro Controller Unit), DSP (Digital Signal Processing) and DPU (Data Processing Unit). Laser transmitting module 102 may include an OPA chip, MEMS (Micro Electro Mechanical System) Scanner, or a mirror. Receiving module 103 may include BPD (Balanced Photodiodes), signal processing circuit, and so on.

In actual application, processing module 101 sends a control signal to laser transmitting module 102 to control laser transmitting module 102 to scan a preset scanning area with the first scanning resolution. Signal receiving module 103 receives the first point cloud data reflected by target 111 in the preset scanning area 110 in the current scanning cycle. Processing module 101 performs target detection based on the first point cloud data, and when a target is detected, processing module 101 updates the control instructions, and sends the updated control instructions to the laser transmitting module 102. Responding to the updated control instructions, laser transmitting module 102, in the next scanning cycle, scans the fine scanning area with the second scanning resolution and scan the observation scanning area with a third scanning resolution. Signal receiving module 103 receives the second point cloud data reflected by target 111 in the fine scanning area and the observation scanning area in the next scanning cycle. It can realize the detection of targets while determining the changes in the surrounding environment of the targets in the preset scanning area, thus ensuring the safety of the targets and improving the accuracy of the target positioning.

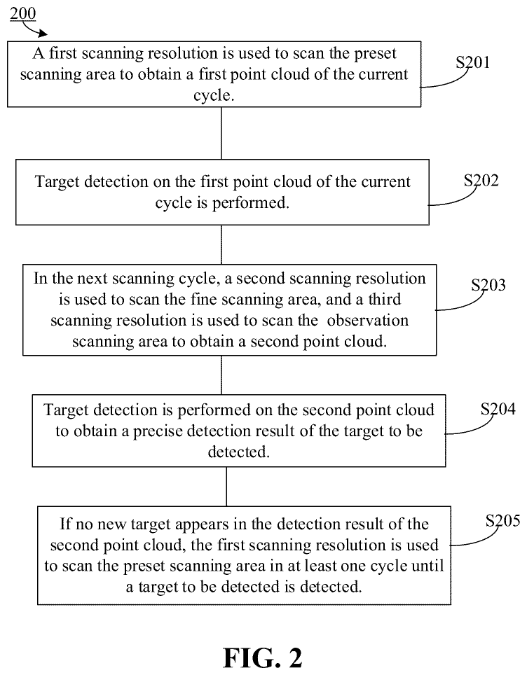

FIG. 2 shows a flow chart of an exemplary target detection method 200 based on laser scanning, according to some embodiments of the present disclosure. Method 200 can be applied to the target detection device 100. Method 200 includes steps S201 and S202.

At step S201, a first scanning resolution is used to scan the preset scanning area to obtain a first point cloud of the current scanning cycle.

Specifically, after determining the range of the preset scanning area, laser signals with the first scanning resolution are transmitted to the preset scanning area to scan the preset scanning area, and the first point cloud data of the current scanning cycle (the scanning cycle set for scanning the preset scanning area with the first scanning resolution, hereinafter referred to as “a first scanning cycle”) is collected.

The preset scanning area can be set according to actual conditions, which is not specifically limited in this embodiment.

It can be understood that to improve the efficiency and accuracy of target detection, in general, the preset scanning area can be set to the current maximum scanning area covered by the laser signals transmitted by the LiDAR.

Specifically, since the main body of the LiDAR transmits laser signals by continuously rotating during operation, the unit of the scanning range corresponding to the laser signals is the azimuth angle. Therefore, the preset scanning area is generally an area corresponding to the azimuth angle range of a certain value centered on the transmitter of the LiDAR.

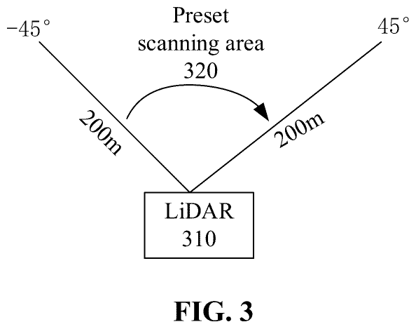

FIG. 3 illustrates an exemplary application scenario diagram of scanning a preset scanning area with a first scanning resolution, according to some embodiments of the present disclosure.

As shown in FIG. 3, the first scanning resolution is used to scan the preset scanning area 320. Preset scanning area 320 is a sector area centered on the transmitter of the LiDAR 310 with a scanning distance of 200 m and an azimuth angle range of −45° to 45°. The first point cloud data of preset scanning area 320 in a first scanning cycle is collected.

Referring back to FIG. 2, at step S202 of method 200, target detection on the first point cloud of the current scanning cycle is performed. If a target is detected, a fine scanning area and an observation scanning area are determined based on the target. The fine scanning area corresponds to the position of the target in the preset scanning area, and the observation scanning area is the area in the preset scanning area except the fine scanning area.

Specifically, after collecting the first point cloud data in the preset scanning area in the first scanning cycle, target detection is performed on the preset scanning area based on the first point cloud data in the first scanning cycle. According to the first point cloud data, when a target is detected in the preset scanning area, the position information of the target will be determined in the preset scanning area based on the first point cloud data, and the fine scanning area will be determined based on the position information of the target in the preset scanning area, the observation scanning area will be determined based on the preset scanning area and fine scanning area. Point cloud data refers to a set of vectors in a three-dimensional coordinate system. The area corresponding to the position of the target in the preset scanning area is the fine scanning area, and in the preset scanning area, the area except the fine scanning area is the observation scanning area.

It should be noted that the position information of the target in the preset scanning area can be determined based on the distance and azimuth angle information between the target and the LiDAR in the first point cloud data.

At step S203, in the next scanning cycle, the second scanning resolution is used to scan the fine scanning area, and the third scanning resolution is used to scan the observation scanning area to obtain a second point cloud. The second scanning resolution is greater than the first scanning resolution, and the third scanning resolution is less than or equal to the first scanning resolution.

Specifically, in the next scanning cycle (hereinafter referred to as “a second scanning cycle”) after a target is detected, laser signals with a second scanning resolution is transmitted within the fine scanning area to scan the fine scanning area, and laser signals with the third scanning resolution is transmitted within the observation scanning area to scan the observation scanning area, and the second point cloud data of the second scanning cycle is collected. The second scanning resolution is greater than the first scanning resolution, and the third scanning resolution is less than or equal to the first scanning resolution.

It should be noted that, the method is set to perform a rough scan on the preset scanning area with the first scanning resolution, so as to detect whether there is a target in the preset scanning area and the approximate position information of the target. The fine scanning area is scanned with the second scanning resolution greater than the first scanning resolution, so as to accurately determine the position information of the target and improve the accuracy of target detection.

In some embodiments, when there are multiple targets, the fine scanning area is the area corresponding to multiple positions of the multiple targets in the preset scanning area.

Specifically, when multiple detection targets are detected in the preset scanning area based on the first point cloud data, the position information of each target in the preset scanning area is determined based on the first point cloud data, and the area corresponding to all position information of all targets in the preset scanning area are determined as the fine scanning area.

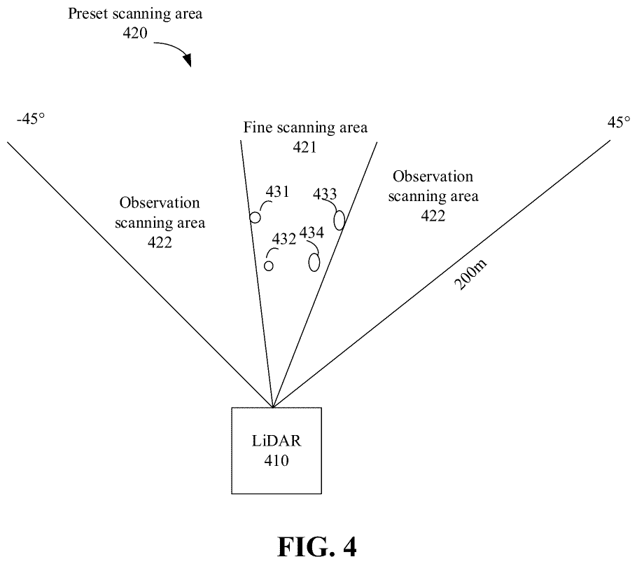

FIG. 4 illustrates an exemplary application scenario diagram of the fine scanning area and the observation scanning area, according to some embodiments of the present disclosure.

As shown in FIG. 4, four targets (e.g., targets 431 to 434) are detected based on the first point cloud data, the position information of each target in the preset scanning area 420 is determined, and the area corresponding to the position information of the four targets in the preset scanning area 420 is determined as the fine scanning area 421, so that the area except the fine scanning area 421 in the preset scanning area is determined as the observation scanning area 422. Laser signals with the second scanning resolution are transmitted within the fine scanning area 421 to scan the fine scanning area 421, and laser signals with the third scanning resolution are transmitted within the observation scanning area 422 to scan the observation scanning area 422, and the second point cloud data of the second scanning cycle is collected.

In some embodiments, after performing target detection on the first point cloud of the current scanning cycle, the method further includes the following step.

If no target is detected in the detection result of the first point cloud, in the next scanning cycle, the first scanning resolution is used to scan the preset scanning area to obtain the corresponding updated first point cloud, until a target is detected in the detection result of the first point cloud.

Specifically, target detection is performed on the preset scanning area according to the first point cloud data of the first scanning cycle. If the detection result of the first point cloud data shows that no target is detected in the preset scanning area, in the next scanning cycle (i.e., the new first scanning cycle), laser signals with the first scanning resolution is still transmitted to the preset scanning area to scan the preset scanning area, and the point cloud data within the preset scanning area in the new first scanning cycle is collected as the updated first point cloud data. If the detection result of the updated first point cloud data shows that no target is detected, it shall return to execute the aforesaid step, i.e., scanning the preset scanning area with the first scanning resolution in the next scanning cycle to obtain the corresponding updated first point cloud, until the target is detected in the preset scanning area according to the updated first point cloud data.

In this implementation, by scanning the preset scanning area with the first scanning resolution to obtain the first point cloud of the current scanning cycle, target detection is performed on the first point cloud of the current scanning cycle, the fine scanning area and the observation scanning area are determined based on the target if a target is detected. In the next scanning cycle, the second scanning resolution is used to scan the fine scanning area, and the third scanning resolution is used to scan the observation scanning area to obtain the second point cloud. The method can realize the detection of targets while determining the changes in the surrounding environment of the targets in the preset scanning area, thus ensuring the safety of the targets and improving the accuracy of the target positioning.

Referring back to FIG. 2, in some embodiments, method 200 can further include step S204.

At step S204, target detection is performed on the second point cloud to obtain a precise detection result of the target.

Specifically, after collecting the second point cloud data of the fine scanning area and the observation scanning area in the second scanning cycle, target detection is performed on the fine scanning area based on the second point cloud data, and a fine detection result of the target (that is, the position information of the target) is obtained, At the same time, based on the second point cloud data, target detection is performed on the fine scanning area and the observation scanning area to determine whether there is a new target.

It can be understood that after the fine scanning area is finely scanned with the second scanning resolution that is greater than the first scanning resolution, the corresponding fine detection result contains position information with higher accuracy.

As an example, but not a limitation, after collecting the first point cloud data, a first number of targets, a first shape and first position information of each target based on the first point cloud data are determined. A corresponding label is added to each target based on the first shape and the first position information of each target. After collecting the second point cloud data, a second number of targets based on the second point cloud data is determined. If the second number is the same as the first number, the current detection result is determined that there is no new target. If the second number is greater than the first number, a second shape and second position information of each target are determined based on the second point cloud data, the second shape and the second position information are matched to the first shape and the first position information, and the target corresponding to the unmatched second shape and the unmatched second position information is taken as a new target, and a new labels is added to the new target.

In some embodiments, method 200 further includes the following step (not shown in FIG. 2).

If a new target exists in the detection result of the second point cloud, the new target is taken as the target, and the fine scanning area and the observation scanning area are updated based on the current target.

Specifically, if the detection result of the observation scanning area shows that there is a new target, the new target is determined as the target. The position information of the target in the preset scanning area is determined based on the second point cloud data. The fine scanning area is updated according to the position information of the target in the preset scanning area. The observation scanning area is updated according to the preset scanning area and the updated fine scanning area. The second scanning resolution is used to scan the updated fine scanning area and the third scanning resolution is used to scan the updated observation scanning area, to obtain the new second point cloud data.

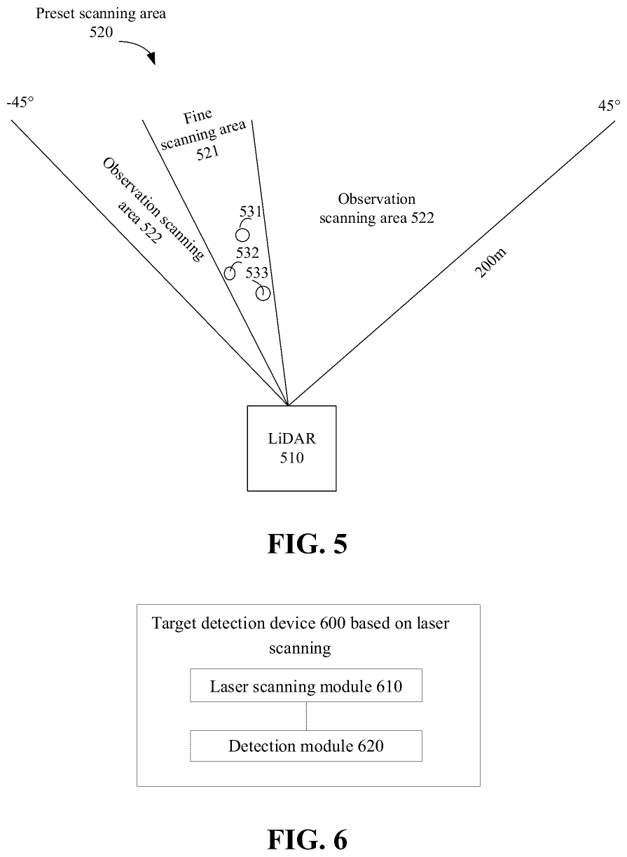

FIG. 5 illustrates an exemplary application scenario diagram of scanning based on new targets, according to some embodiments of the present disclosure.

As shown in FIG. 5, three new targets (e.g., targets 531 to 533) are detected based on the second point cloud data. The position information of the corresponding area of the three new targets in the preset scanning area 520 is determined to be the new fine scanning area 521, and the new observation scanning area 522 is the area in the preset scanning area 520 except the new fine scanning area 521. Laser signals with the second scanning resolution are transmitted to the new fine scanning area 521 to scan the new fine scanning area 521, and laser signals with the third scanning resolution are transmitted to the new observation scanning area 522 to scan the new observation scanning area 522. The second point cloud 2 data of the new second scanning cycle is collected.

In some embodiments, the step of using the second scanning resolution to scan the fine scanning area and using the third scanning resolution to scan the observation scanning area, to obtain the second point cloud further includes the following steps.

A frame rate is reduced to obtain the second scanning resolution, and the second scanning resolution is used to scan the fine scanning area.

The frame rate is increased to obtain the third scanning resolution, and the third scanning resolution is used to scan the observation scanning area to obtain the second point cloud.

Specifically, the scanning resolution specifically refers to the angular resolution. The frame rate represents the number of revolutions of the LiDAR motor in one second, e.g., the number of scanning performed in one second. Since the resolution varies with the frame rate, the first scanning resolution can be adjusted to the second scanning resolution by lowering the frame rate, and laser signals with the second scanning resolution are transmitted to the fine scanning area to scan the fine scanning area. The frame rate can be increased to adjust the first scanning resolution to the third scanning resolution, and laser signals with the third scanning resolution are transmitted to the observation scanning area to scan the observation scanning area, and the second point cloud data of the second scanning cycle is collected.

In this implementation, by scanning the fine scanning area with a greater second scanning resolution and collecting the second point cloud data for target detection to obtain the fine detection result of the corresponding target, the method can accurately determine the position information of the target in the preset scanning area, improving the accuracy of target detection. At the same time, by detecting whether there is a new target according to the second point cloud data, the method can position targets while observing the surrounding environment, further improving the efficiency of target detection.

Referring back to FIG. 2, in some embodiments, method 200 can further include step S205.

At step S205, if no new target exists in the detection result of the second point cloud, the first scanning resolution is used to scan the preset scanning area in at least one scanning cycle until a target is detected.

Specifically, if according to the second point cloud data, the detection results of target detection in the fine scanning area and the observation scanning area show that there is no new target existed, in at least one subsequent scanning cycle, laser signals with the first scanning resolution is transmit within the preset scanning area to scan the preset scanning area until a target is detected.

In this implementation, by performing multiple cycles of scanning on the preset scanning area when no new target is detected based on the detection result of the second point cloud, the method can achieve real-time monitoring of the preset scanning area and avoid the omission of new targets that exist due to environmental changes, further improving the accuracy and reliability of target detection.

In some embodiments, the target detection method based on laser scanning can further include the following steps.

The first scanning resolution is used to scan the preset scanning area to obtain the first point cloud.

Target detection is performed on the first point cloud. If a target is detected, the fine scanning area and the observation scanning area are determined based on the target. The fine scanning area corresponds to the position of the target in the preset scanning area, and the observation scanning area is the area in the preset scanning area except the fine scanning area.

The second scanning resolution is used to scan the fine scanning area, and the third scanning resolution is used to scan the observation scanning area to obtain the second point cloud. The number of point clouds per unit area in the fine scanning area when scanning with the second scanning resolution is larger than the number of point clouds per unit area in the preset scanning area when scanning with the first scanning resolution. The number of point clouds per unit area in the observation scanning area when scanning with the third scanning resolution is smaller than the number of point clouds per unit area in the preset scanning area when scanning with the first scanning resolution.

Specifically, in this implementation, whether there is a target is determined based on the first point cloud obtained in the current scanning cycle. When a target is detected, the fine scanning area and the observation scanning area are determined based on the target, and the second scanning resolution to scan the fine scanning area in the next scanning cycle, and the third scanning resolution is used to scan the observation scanning area. For example, the first point cloud is obtained by scanning with the first scanning resolution M1×N1. When confirming that there is a target, the fine scanning area is scanned with the second scanning resolution M2×N2, and the observation scanning area is scanned with the third scanning resolution M3×N3, wherein (M1×N1)>(M1×N1)>(M3×N3).

In some embodiments, the fine scanning area is a corresponding area of each target in the preset scanning area. That is, the fine scanning area may be one or multiple, may be independent of each other, or may be continuous.

In some embodiments, the target detection method based on laser scanning further includes the following steps.

Whether the state of the target changes according to the second point cloud is determined. The state of the target includes at least one of the number, speed, azimuth angle and distance of the target.

When the state of the target changes, the fine scanning area and the observation scanning area shall be updated based on the target determined with the second point cloud.

In some embodiments, the target detection method based on laser scanning further includes the following steps.

When the distance of the target is greater than or equal to the set safety distance, the frame rate may be reduced, the scanning resolution of the fine scanning area may be increased, and the scanning resolution of the observation scanning area may be increased.

When the distance of the target is less than the set safety distance, and the moving speed of the gradually approaching the target is greater than the preset speed, the frame rate may be increased, the scanning resolution of the fine scanning area may be reduced, and the scanning resolution of the observation scanning area may be reduced.

It should be understood that the sequence number of each step in the aforesaid embodiments does not mean the order of execution. The execution order of each process shall be determined by its function and internal logic, and shall not constitute any limitation on the implementation process of the embodiments of the present application.

In addition, in some embodiments, when no target is detected based on the detection result of the second point cloud, it is set to change the scanning resolution and return to the step of scanning the preset scanning area with the first scanning resolution.

Corresponding to the target detection method based on laser scanning described in the aforesaid embodiments, FIG. 6 shows a structural block diagram of an exemplary target detection device 600 based on laser scanning, according to some embodiments of the present disclosure. For convenience of explanation, only the parts relevant to embodiments of the present disclosure are shown.

Referring to FIG. 6, target detection device 600 based on laser scanning includes a laser scanning module 610 and a detection module 620. Laser scanning module 610 is configured to scan the preset scanning area with the first scanning resolution to obtain the first point cloud of the current scanning cycle. Laser scanning module 610 may include an OPA chip, MEMS (Micro Electro Mechanical System) Scanner, or a mirror.

Detection module 620 is configured to perform target detection on the first point cloud of the current scanning cycle, and determine the fine scanning area and the observation scanning area based on the target if a target is detected. Detection module 620 may be optical lenses, optical antennas, a detector, a detector array, for example, an Avalenche Photo-Diodes (APD) array, a mixer, coherent detector, a beam combiner, or the like. The fine scanning area corresponds to the position of the target in the preset scanning area; the observation scanning area is the area in the preset scanning area except the fine scanning area.

Laser scanning module 610 is further configured to scan the fine scanning area with the second scanning resolution to in the next scanning cycle and scan the observation scanning area with the third scanning resolution, to obtain the second point cloud. The second scanning resolution is greater than the first scanning resolution, and the third scanning resolution is less than or equal to the first scanning resolution.

In some embodiments, when there are multiple targets, the fine scanning area is the area corresponding to multiple positions of the multiple targets in the preset scanning area.

In some embodiments, detection module 620 is further configured to perform target detection on the second point cloud to obtain a precise detection result of the target.

In some embodiments, laser scanning module 610 is further configured to, if a new target exists in the detection result of the second point cloud, take the new target as a target, and update the fine scanning area and the observation scanning area based on the target.

In some embodiments, if no new target exists in the detection result of the second point cloud, laser scanning module 610 is further configured to scan the preset scanning area with the first scanning resolution in at least one scanning cycle until the target is detected.

In some embodiments, laser scanning module 610 further includes a first scanning unit and a second scanning unit. The first scanning unit and the second scanning unit may be an optical device, a polygon mirror, a galvanometer, an OPA array, or any other type of scanner.

The first scanning unit is configured to reduce the frame rate to obtain the second scanning resolution, and scan the fine scanning area with the second scanning resolution.

The second scanning unit is configured to increase the frame rate to obtain the third scanning resolution, and scan the observation scanning area with the third scanning resolution. The second point cloud is obtained by scanning the fine scanning area with the second scanning resolution and scanning the observation scanning area with the third scanning resolution.

In some embodiments, if no target is detected in the detection result of the first point cloud, in the next scanning cycle, laser scanning module 610 is further configured to scan the preset scanning area with the first scanning resolution to obtain a corresponding updated first point cloud, until the target is detected in the detection result of the first point cloud.

In this implementation, by scanning the preset scanning area with the first scanning resolution to obtain the first point cloud of the current scanning cycle, performing target detection on the first point cloud of the current scanning cycle, the fine scanning area and the observation scanning area are determined based on the target if a target is detected, and in the next scanning cycle, fine scanning area is scanned with the second scanning resolution and to scan the observation scanning area is scanned with the third scanning resolution, to obtain the second point cloud, the method can realize the detection of targets while determining the changes in the surrounding environment of the targets in the preset scanning area, thus ensuring the safety of the targets and improving the accuracy of the target positioning.

In some embodiments, target detection device 600 based on laser scanning further includes an area scanning module and an area dividing module. The area scanning module may include an OPA chip, MEMS (Micro Electro Mechanical System) Scanner, or a mirror. The area dividing module may include a processor, a controller, or a communication device, and the like.

The area scanning module is configured to scan the preset scanning area with the first scanning resolution to obtain the first point cloud.

The area dividing module is configured to perform target detection on the first point cloud, and determine the fine scanning area and the observation scanning area based on the target if a target is detected. The fine scanning area corresponds to the position of the target in the preset scanning area. The observation scanning area is the area in the preset scanning area except the fine scanning area.

The area scanning module is further configured to scan the fine scanning area with the second scanning resolution and scan the observation scanning area with the third scanning resolution, to obtain the second point cloud. The number of point clouds per unit area in the fine scanning area when scanning with the second scanning resolution is larger than the number of point clouds per unit area in the preset scanning area when scanning with the first scanning resolution. The number of point clouds per unit area in the observation scanning area when scanning with the third scanning resolution is smaller than the number of point clouds per unit area in the preset scanning area when scanning with the first scanning resolution.

In some embodiments, the fine scanning area is a corresponding area of each target in the preset scanning area.

In some embodiments, target detection device 600 based on laser scanning further includes a third detection module and an updating module. The third detection module may be optical lenses, optical antennas, a detector, a detector array, for example, an Avalenche Photo-Diodes (APD) array, a mixer, coherent detector, a beam combiner, or the like. The updating module may include a processor, a controller, or a communication device, and the like.

The third detection module is configured to determine whether the state of the target changes according to the second point cloud. The state of the target comprises at least one of the number, speed, azimuth angle and distance of the target.

The updating module is configured to update the fine scanning area and the observation scanning area based on the target determined with the second point cloud when the state of the target changes.

In some embodiments, the target detection device 600 based on laser scanning further includes a first resolution adjustment module and a second resolution adjustment module. The first resolution adjustment module and the second resolution adjustment module each may include a processor, a controller, or a communication device, and the like.

The first resolution adjustment module is configured to reduce the frame rate, increase the scanning resolution of the fine scanning area, and reduce the scanning resolution of the observation scanning area when the distance of the target is greater than or equal to the set safety distance.

The second resolution adjustment module is configured to increase the frame rate, increase the scanning resolution of the fine scanning area, and reduce the scanning resolution of the observation scanning area when the distance of the target is less than the set safety distance, and the moving speed of the gradually approaching the target is greater than the preset speed.

It should be noted that the information interaction, execution process, etc. between the aforesaid devices/units are based on the same concept as the embodiments of the method of the present application. The specific functions and technical effects brought by the method can be specifically referred to the embodiments of the method, and will not be described here.

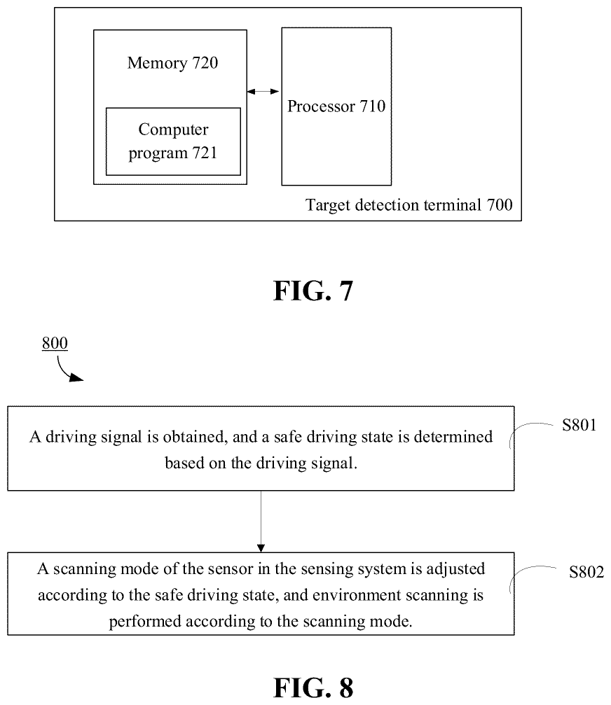

FIG. 7 is a structural block diagram of an exemplary target detection terminal 700, according to some embodiments of the present disclosure. As shown in FIG. 7, target detection terminal 700 includes one or more processor 710 (only one is shown in FIG. 7), a memory 720 and a computer program 721 stored in memory 720 and capable of running on the one or more processor 710. When processor 710 executes computer program 722, the steps in any of the aforesaid embodiments of the target detection method based on laser scanning are implemented.

Target detection terminal 700 may be a computing device such as a desktop computer, a notebook, a handheld computer, a cloud server, etc. Target detection terminal 700 may comprise, but is not limited to, processor 710 and memory 720. Those skilled in the art can understand that FIG. 7 is only an example of target detection terminal 700 and does not constitute a limitation on target detection terminal 700. Target detection terminal 700 may include more or less components than shown in the figure, or some combination of components, or different components, for example, it may also comprise input/output devices, network access devices, etc.

Processor 710 may be a central processing unit (CPU); the processor 710 may also be other general-purpose processors, digital signal processors (DSP), application specific integrated circuits (ASIC), field-programmable gate arrays (FPGA) or other programmable logic devices, discrete gate or transistor logic devices, discrete hardware components, etc. A general-purpose processor may be a microprocessor, or the processor may be any conventional processor, etc.

In some embodiments, memory 720 may be an internal storage unit of target detection terminal 700, such as a hard disk or memory of target detection terminal 700. In other embodiments, memory 720 may also be an external storage device of target detection terminal 700, such as a plug-in hard disk, a smart media card (SMC), a secure digital (SD) card, or a flash card equipped on target detection terminal 700. Further, memory 720 may also comprise both an internal storage unit of target detection terminal 700 and an external storage device. Memory 720 is used to store operating systems, application programs, boot loaders, data, and other programs, such as program codes of the computer program. Memory 720 can also be used to temporarily store data that has been output or is to be output.

Embodiments of the present disclosure also provide a sensing method for sensing system.

FIG. 8 shows a flow chart of an exemplary sensing method 800 for sensing system, according to some embodiments of the present disclosure. As shown in FIG. 8, the sensing method 800 for sensing system includes steps S801 and S802. The sensing system includes a sensor and a controller, the controller is coupled to the sensor, and the sensor includes at least one of a LiDAR, a camera, and a millimeter-wave radar.

At step S801, a driving signal is obtained, and a safe driving state is determined based on the driving signal.

Since a vehicle (for example, including a target detection device described above) may be in a dangerous situation due to some external factors while driving, the response capability of the vehicle can be improved by increasing the frequency of scanning the environment around the vehicle or the targets around the vehicle that may affect the safety of the vehicle, thereby improving the safety of the vehicle driving on the road. In this implementation, the controller of the sensing system obtains a driving signal to determine a current state of the vehicle as a safe driving state when the vehicle is determined to be in a dangerous situation based on the driving signal. The safe driving state is the corresponding status when the vehicle may currently have safety hazards. The driving signal includes but is not limited to a command signal issued instructed by a host computer associated with the sensing system, a signal generated by the sensing system by sensing target changes in a scenario, and a signal generated by the vehicle when the vehicle is out of control.

It can be understood that the host computer can obtain the situation in front of the vehicle in advance based on the obtained road information. When the vehicle is determined to be in danger based on the situation in front of the vehicle, a command signal is issued, so that the sensing system determines that the current vehicle needs to be in a safe driving state, so as to carry out corresponding response measures. In addition, relevant staff can issue a command signal through the host computer as needed, so that the sensing system determines that the current vehicle needs to be in a safe driving state based on the command signal. In the present disclosure, for the convenience of distinction, the current vehicle is regarded as a vehicle running on the road served by the sensing system.

It can be understood that when the current vehicle is out of control, objects around the current vehicle may cause secondary damage to the current vehicle. Therefore, when the driving signal is a signal generated by the current vehicle itself when it's out of control, the sensing system determines that the current vehicle needs to be in a safe driving state, so that the sensing system can take corresponding response measures based on the determined vehicle state.

At step S802, a scanning mode of the sensor in the sensing system is adjusted according to the safe driving state, and environment scanning is performed according to the adjusted scanning mode.

When the sensing system determines that the current vehicle needs to be in a safe driving state, corresponding measures are required to improve the response capability of the current vehicle to avoid the vehicle being in a dangerous situation. In this implementation, the controller of the sensing system responds to the safe driving state of the current vehicle by adjusting the scanning mode of the sensor of the sensing system. The adjustment of scanning mode includes but is not limited to adjusting a frame rate, adjusting a resolution, and adjusting a frequency, etc., for example, increasing or decreasing the frame rate. The frame rate is the number of scanning performed per second.

In some embodiments, the determination of the safe driving state based on the driving signal may include: when the driving signal is a signal generated by sensing a change in a target within a preset scanning area of the scenario, it indicates that there may be an obstacle that may cause danger to the vehicle in the surrounding environment of the current vehicle on the road, and the obstacle is the target that changes. The controller of the sensing system determines that the current vehicle needs to be in a safe driving state. Accordingly, the adjustment of the scanning mode of the sensor in the sensing system according to the safe driving state may include: the controller determines a change type of the target in a safe driving state, and adjusts the frame rate of the sensor according to the change type of the target, thereby responding to different changes of the target in the scenario according to the change in frame rate, so as to improve the safety of the vehicle. The target includes but is not limited to a motor vehicle, a non-motor vehicle, a road test equipment, a pedestrian, an obstacle, etc., and the obstacle may be object dropped in a high falling object scenario.

In some embodiments, if the change type is an emergence of a new target, that is, a new target suddenly exists in the scenario. Correspondingly, the controller reduces the frame rate according to the change type to detect the new target. For example, in a high-speed driving scenario, if a new target exists, the target is generally far away from the current vehicle, so the scanning frame rate needs to be reduced, and the scanning resolution can be increased, thereby increasing detection distance and obtaining a longer response time.

In some embodiments, a newly existing target may interact with the environment around the target, thereby affecting the current vehicle. Therefore, to ensure the safety of the vehicle, the reduction of the frame rate to detect the new target may further include: the controller reduces the frame rate to scan an adjacent area of the new target. The adjacent area may be an area within a preset range around the new target, for example, the fine scanning area.

Although a new target exists, emergencies may occur in other areas of the scanning scenario of the current vehicle, so the controller in the sensing system may also control the sensors to scan other areas at the original frame rate. The other areas are areas in the preset scanning area other than the adjacent area of the new target, and the original frame rate (i.e., a first frame rate) is the frame rate before adjustment.

In some embodiments, if the change type is a change in a motion state of a detected target or an existence of a special target, it indicates that the target may cause danger to the current vehicle, and the sensing system needs to determine that the vehicle is in a safe driving state. Correspondingly, the adjustment of the frame rate of the sensor of the sensing system for scanning according to the change type may include: the controller increases the frame rate to detect the detected target, to obtain a changing state of the target in time. The special target is an object that causes serious safety hazards to the vehicle.

The distance or speed information of the detected target can be used to determine whether the change in the motion state of the detected target poses a danger to the current vehicle. It can be understood that based on the principle of maintaining a distance between vehicles in safe driving, that is, the distance between vehicles is about one thousandth of the vehicle speed. For example, to maintain a safe distance between vehicles, the vehicle speed must be less than 50 km/h when the relative distance between vehicles is 50 m. Therefore, the controller can set a relative relationship between distance information and speed information.

When the relative relationship changes in a way that affects the safety of the current vehicle, it means that the current vehicle needs to be in a safe driving state. For example, when the scenario is a road scenario and the detected target is a vehicle, the motion state changes that affect the safety of the vehicle may include: when the distance information of the vehicle is detected to be less than a first preset distance threshold, the changed speed information of the vehicle is greater than or equal to a preset speed threshold, indicating that changes in the motion state of the detected target may cause danger to the current vehicle, and the sensing system needs to determine that the vehicle is in a safe driving state. For example, if the distance between vehicles is less than 120 m and the change in vehicle speed is greater than or equal to 120 km/h, it means that the current vehicle has safety hazards, and the current vehicle needs to be determined to be in a safe driving state.

For example, the sensing system can determine the speed information and distance information of the vehicle according to a Time of Flight (TOF) method. Specifically, the sensor of the sensing system scans the target, and the controller determines a first scanning time difference, which is the difference between the laser transmitting time and the laser receiving time when scanning the target. The controller determines a first distance information of the target based on the time difference. Then the sensor scans the target again. The controller determines a second scanning time difference according to the above manner, and then determines a second distance information based on the second scanning time difference. Finally, the controller determines the speed information of the target based on a difference between the first distance information and the second distance information, and a difference between the first scanning time difference and the second scanning time difference.

By way of example, the sensing system can determine the speed information and distance information of the vehicle based on Frequency Modulated Continuous Wave (FMCW) radar ranging or the principle of speed measurement. Specifically, the sensor of the sensing system scans the target, and the controller determines a scanning frequency difference based on the frequency signal obtained by scanning. The scanning frequency difference is a difference between a laser transmitting frequency and a laser receiving frequency when scanning the target. The controller determines the distance information and speed information of the target based on the scanning frequency difference.

In some embodiments, during the current vehicle driving process, it may encounter situations such as emergency braking of a target vehicle ahead or objects being thrown from high altitude, or in the urban street driving environment, the surrounding obstacles are close, and the corresponding driving distance is short. All these situations may cause safety hazards to the current vehicle, so when the distance information of the target is less than a second preset distance threshold, the controller increases the frame rate to detect the target to improve the vehicle's response capability to changes in the surrounding environment of the vehicle.

In some embodiments, because the target is changing and the current vehicle is also changing, and during the two changes, only based on the fixed scanning direction and scanning angle, it is not possible to scan the changing target well, and thus it is impossible to obtain a better accurate scanning result. So, if the change type is a change in the motion state of the detected target, the controller adjusts the scanning direction and scanning angle of the sensor of the sensing system according to the change type and transmits a scanning signal to the target according to the obtained scanning direction and scanning angle. For example, if an OPA LiDAR is used for scanning, as the sensor of the sensing system, the direction and azimuth angle of transmitting laser can be obtained.

It can be understood that if a two-dimensional scan is performed on the target, in which the scanning in the horizontal direction may be achieved by phase modulation, and scanning in the vertical may be achieved by wavelength modulation, so the controller can determine the corresponding control signal according to the change type. For example, the control signal may be determined by changing the amplitude and frequency of the control signal applied to the sensor. The thermal modulation effect may be changed correspondingly by the control signal. When the change gradient of voltage or frequency is small, the change of thermal modulation phase is small and the corresponding horizontal angular resolution is small, where the horizontal angular resolution is the smallest angle in the horizontal direction that can be clearly distinguished in the field of view. When the change gradient of voltage or frequency is large, the change of thermal modulation phase is large, and the corresponding horizontal angular resolution is large. When the changing gradient of wavelength in the vertical direction is small, the vertical angular resolution is small, and when the changing gradient of wavelength is large, the vertical angular resolution is large.

In some embodiments of the present disclosure, a driving signal is obtained to determine a safe driving state based on the driving signal, and then a scanning mode of the sensor of the sensing system is adjusted according to the safe driving state. The environment is scanned according to the scanning mode. Therefore, when the safe driving state is determined, the scanning frame rate of the sensor is adjusted according to the safe driving state to improve the response speed of the vehicle in dangerous situations.

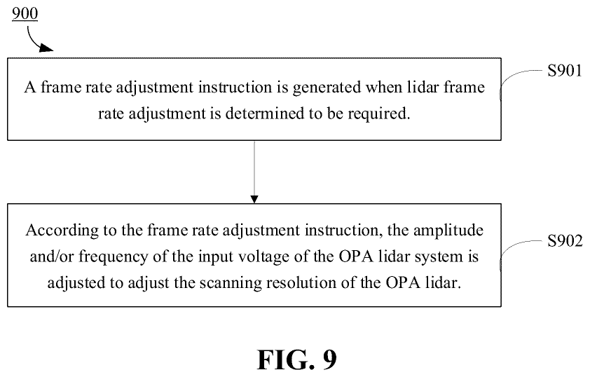

FIG. 9 shows a flow chart of an exemplary method 900 for controlling an OPA LiDAR, according to some embodiments of the present disclosure. In this implementation, using the OPA LiDAR for scanning includes the steps described in the method 800. As shown in FIG. 9, the difference from method 800 is that method 900 for controlling the OPA LiDAR may include steps S901 and S902.

At step S901, a frame rate adjustment instruction is generated when LiDAR frame rate adjustment is determined to be required.

In this implementation, the controller of the sensing system determines whether the LiDAR frame rate needs to be adjusted, which can be determined by presetting the frame rate configuration, for example, by setting the time of frame rate change, the number of frame rate change, etc. For example, the time of frame rate change refers to that the frame rate is required to change after a preset duration or at a preset time of a day (e.g., 6 pm for a rush hour). The number of frame rate change refers to that the frame rate is required to change after a preset number of scans, for example, the frame rate is required to change once after every one thousand scans. Whether the LiDAR frame rate needs to be adjusted can also be determined by determining whether the current vehicle is in a safe driving state.

In some embodiments, the controller can obtain the current time of the current vehicle. If the current time meets the preset frame rate change time, it is determined that the LiDAR frame rate needs to be adjusted.

In some embodiments, the controller can obtain the number of scans of the current vehicle. If the number of scans meets the preset number of frame rate change, it is determined that the LiDAR frame rate needs to be adjusted.

In some embodiments, the controller can obtain the current sensing scenario of the current vehicle. If the current vehicle is determined to be in a safe driving state according to the current sensing scenario, it is determined that the LiDAR frame rate needs to be adjusted.

In some embodiments, the controller can also obtain the current time, the number of scans, and the current sensing scenario at the same time, and determine whether the LiDAR frame rate needs to be adjusted based on at least two of the current time, the number of scans, and the current sensing scenario through combined consideration.

It can be understood that the scanning technology using OPA LiDAR is a new beam pointing control technology developed based on microwave phased array scanning theory and technology, with the advantages of no inertial device, good precision and stability, and arbitrary direction control, which can realize the change of scanning frame rate by adjusting the control signal (i.e., the frame rate adjustment instruction) to suit different driving scenarios and respond to different needs of users. The changing frame rate corresponding to the OPA LiDAR scanning is ≥5 Hz. In some embodiments, the changing of frame rate can be set to ≥100 Hz according to user needs.

At step S902, according to the frame rate adjustment instruction, the amplitude and/or frequency of the input voltage of the OPA LiDAR system is adjusted to adjust the scanning resolution of the OPA LiDAR. The higher the scanning resolution of the OPA LiDAR is, the lower the corresponding frame rate is. The lower the scanning resolution of the OPA LiDAR is, the higher the corresponding frame rate is.

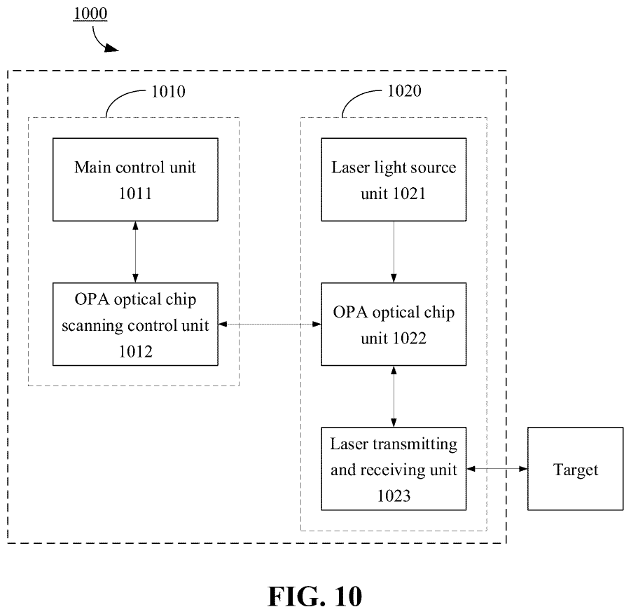

FIG. 10 illustrates a structural block diagram of an exemplary sensing system 1000, according to some embodiments of the present disclosure. As shown in FIG. 10, sensing system 1000 includes a controller 1010 and an OPA LiDAR system 1020 coupled to control 1010. Controller 1010 includes a main controller unit 1011 and an OPA optical chip scanning control unit 1012. OPA LiDAR system 1020 includes a laser light source unit 1021, an OPA optical chip unit 1022, and a laser transmitting and receiving unit 1023. Laser light source unit 1021 is configured to generate a scanning laser signal. Laser light source unit 1021 may include a laser. OPA optical chip unit 1022 may include a plurality of OPA optical chips. OPA optical chip unit 1022 is configured to control the frame rate of the scanning laser signal (in some embodiments, including the scanning direction or scanning angle) according to the input voltage sent by OPA optical chip scanning control unit 1012 of controller 1010, and utilize the photodiode integrated on the OPA optical chip to convert the optical signal into an electrical signal and sends the electrical signal to OPA optical chip scanning control unit 1012, so that OPA optical chip scanning control unit 1012 sends the electrical signal to main control unit 1011 of controller 1010. Main control unit 1011 is coupled to OPA optical chip scanning control unit 1012 and main control unit 1011 is configured to issue control instructions to OPA optical chip scanning control unit 1012 to control the scanning laser signal. Laser transmitting and receiving unit 1023 is configured to collimate the scanning detection light and transmit it to the target and receive the signal detection light reflected by a target. Laser transmitting and receiving unit 1023 may include a transmitter and a receiver.

It can be understood that the image output by the OPA LiDAR is also called a “point cloud” image, and the azimuth angle between two adjacent points is the angular resolution. A point cloud image represents one frame, which corresponds to a scan result on the target. Since the sampling rate of LiDAR is fixed, that is, the number of scanning points output by the OPA LiDAR system per unit time is fixed, so when the scanning resolution decreases, the number of points output in one scanned frame decreases, and correspondingly the scanning frame rate will increase; when the scanning resolution increases, the number of points output in one scanned frame increases, and correspondingly the scanning frame rate will decrease. The sampling rate represents the number of times the LiDAR can effectively collect data per second, which can be intuitively understood as the number of point clouds generated in one second. The sampling rate can be calculated by the angular resolution (i.e., the scanning resolution) and the frame rate, when the angular resolution is 0.08°, and the scanning angle range of the view field is 360°, the number of point clouds in each frame is:

$$( 360 ° ) / ( 0.08 ° ) = 4 , 500$$

When the sampling rate is 10 frames per second, the corresponding number of point clouds per second is:

$$4 , 500 \times 10 = 45 , 000$$

In some embodiments, the controller may reduce the amplitude of the input voltage or the frequency of the input voltage of the OPA LiDAR system by a preset value according to the frame rate adjustment instruction to increase the frame rate.

In this implementation, when it is detected that the distance information of the vehicle is less than the preset safe distance, or the changed vehicle speed is not less than the preset speed, the amplitude and/or the frequency of the input voltage is adjusted according to the frame rate adjustment instruction by a preset value. For example, when the relative distance of the vehicle is 50 m and the vehicle speed is less than 50 km/h, the amplitude or the frequency of the input voltage can be adjusted to increase the frame rate. For another example, when the distance between vehicles is less than 120 m and the change in vehicle speed is greater than or equal to 120 km/h, the amplitude and/or the frequency of the input voltage is adjusted to increase the frame rate.

In some embodiments, when the frame rate adjustment instruction complies with the preset instruction, the amplitude or the frequency is reduced by a preset value according to the frame rate adjustment instruction to increase the frame rate. The preset instruction includes an instruction generated when the current vehicle is in a dangerous situation, so as to make the vehicle enter a safe driving state, thereby increasing the frame rate. For example, as described in method 200, the frame rate is increased when certain changes occur to the target.

In some embodiments, when it is determined that the LiDAR frame rate needs to be adjusted, a frame rate adjustment instruction is generated. According to the frame rate adjustment instruction, the amplitude and/or the frequency of the input voltage of the OPA LiDAR system is adjusted to adjust the scanning resolution of the OPA LiDAR. The higher the scanning resolution of OPA LiDAR is, the lower the frame rate is, and the lower the scanning resolution of OPA LiDAR is, the higher the frame rate is. Therefore, it facilitates the vehicle to respond according to various scenarios.

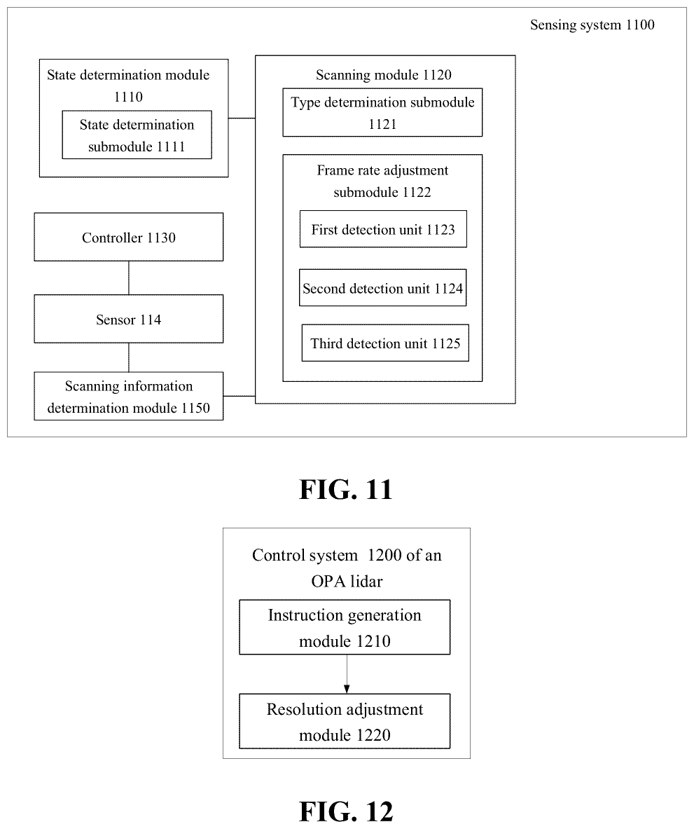

Corresponding to sensing method 900 for sensing system, FIG. 11 shows a structural block diagram of an exemplary sensing system 1100, according to some embodiments of the present disclosure. As shown in FIG. 11, sensing system 1100 includes a state determination module 1110 and a scanning module 1120.

State determination module 1110 is configured to obtain a driving signal and determine a safe driving state based on the driving signal. In some embodiments, state determination module 1110 may include a processor, a controller, or a communication device, and the like.

Scanning module 1120 is configured to adjust the scanning mode of the sensor in the sensing system according to the safe driving state to perform environment scanning according to the scanning mode. Scanning module 1120 may include an OPA chip, MEMS (Micro Electro Mechanical System) Scanner, or a mirror.

In some embodiments, state determination module 1110 may include a state determination submodule 1111 configured to determine the safe driving state when the driving signal is a signal generated by sensing a change in a target within a preset area in the scenario. State determination submodule 1111 may include a processor, a controller, or a communication device, and the like.

Correspondingly, scanning module 1120 may include a type determination submodule 1121 configured to determine the change type of the target according to the safe driving state, and a frame rate adjustment submodule 1122 configured to adjust the frame rate of the sensor in the sensing system according to the change type. Type determination submodule 1121 and frame rate adjustment submodule 1122 each may include a processor, a controller, or a communication device, and the like. In some embodiments, sensing system 1100 may further include a controller 1130 and a sensor 1140, controller 1130 is coupled to sensor 1140, and sensor 1140 includes at least one of a LiDAR, a camera, and a millimeter-wave radar.

In some embodiments, if the change type is the emergence of a new target, frame rate adjustment submodule 1122 may include a detection unit 1123 configured to detect the new target by reducing the frame rate according to the change type. Detection unit 1123 may be optical lenses, optical antennas, a detector, a detector array, for example, an Avalenche Photo-Diodes (APD) array, a mixer, coherent detector, a beam combiner, or the like.

In some embodiments, detection unit 1123 may include a first scanning subunit configured to reduce the frame rate to scan the adjacent area where a new target exists. The first scanning subunit may be optical lenses, optical antennas, a detector, a detector array, for example, an Avalenche Photo-Diodes (APD) array, a mixer, coherent detector, a beam combiner, or the like.

In some embodiments, detection unit 1123 may include a second scanning subunit configured to scan other areas at the original frame rate. The other areas are areas in the preset area other than the adjacent area where the new target exists, and the original frame rate is the frame rate before adjustment. The second scanning subunit may be optical lenses, optical antennas, a detector, a detector array, for example, an Avalenche Photo-Diodes (APD) array, a mixer, coherent detector, a beam combiner, or the like.

In some embodiments, if the change type is a change in the motion state of the detected target or the presence of a special target, detection unit 1123 is further configured to detect the detected target by increasing the frame rate according to the change type.

In some embodiments, when the scenario is a road scenario and the detected target is a vehicle, the motion state changes may include when the distance information of the vehicle is detected to be less than a first preset distance threshold, the changed speed information of the vehicle is greater than or equal to the preset speed threshold.

In some embodiments, detection unit 1123 is further configured to increase the frame rate to detect the target when the distance information of the target is less than a second preset distance threshold.

In some embodiments, sensing system 1100 may further include a scanning information determination module 1150 configured to adjust the scanning direction and scanning angle of sensor 1140 according to the change type if the change type is a change in the motion state of the detected target. Scanning information determination module 1150 may include a processor, a controller, or a communication device, and the like.

In some embodiments, a driving signal is obtained to determine a safe driving state, and the scanning mode of the sensor of the sensing system is adjusted according to the safe driving state, and the environment is scanned according to the scanning mode. When the safe driving state is determined, the scanning frame rate of the senso is adjusted according to the state to improve the vehicle's response speed in dangerous situations.

Corresponding to the aforesaid method for controlling an OPA LiDAR, FIG. 12 shows a structural block diagram of an exemplary control system 1200 of an OPA LiDAR, according to some embodiments of the present disclosure. As shown in FIG. 12, control system 1200 of an OPA LiDAR may include an instruction generation module 1210 configured to generate a frame rate adjustment instruction when it is determined that LiDAR frame rate adjustment is required, and a resolution adjustment module 1220 configured to adjust the amplitude or frequency of the input voltage of the OPA LiDAR system according to the frame rate adjustment instruction, so as to adjust the scanning resolution of the LiDAR. The higher the scanning resolution of the LiDAR is, the lower the corresponding frame rate is; and the lower the scanning resolution of the LiDAR is, the higher the corresponding frame rate is. Instruction generation module 1210 and resolution adjustment module 1220 each may include a processor, a controller, or a communication device, and the like.

In some embodiments, control system 1200 of an OPA LiDAR may further include an information acquisition module configured to obtain the current moment, number of scans and current sensing scenario; and a frame adjustment module configured to determine whether LiDAR frame rate adjustment is required based on at least one of the current moments, the number of scans, and the current sensing scenario. The information acquisition module and the frame adjustment module each may include a processor, a controller, or a communication device, and the like.

In some embodiments, control system 1200 of an OPA LiDAR may further include an adjustment module configured to reduce the amplitude or the frequency by a preset value according to the frame rate adjustment instruction when the frame rate adjustment instruction complies with the preset instruction, so as to increase the frame rate. The adjustment module may include a processor, a controller, or a communication device, and the like.

Those skilled in the art can clearly understand that for the convenience and simplicity of description, the specific working processes of the aforesaid devices and modules can be obtained by reference to the corresponding processes in the foregoing system embodiments and method embodiments, and will not be described again here.

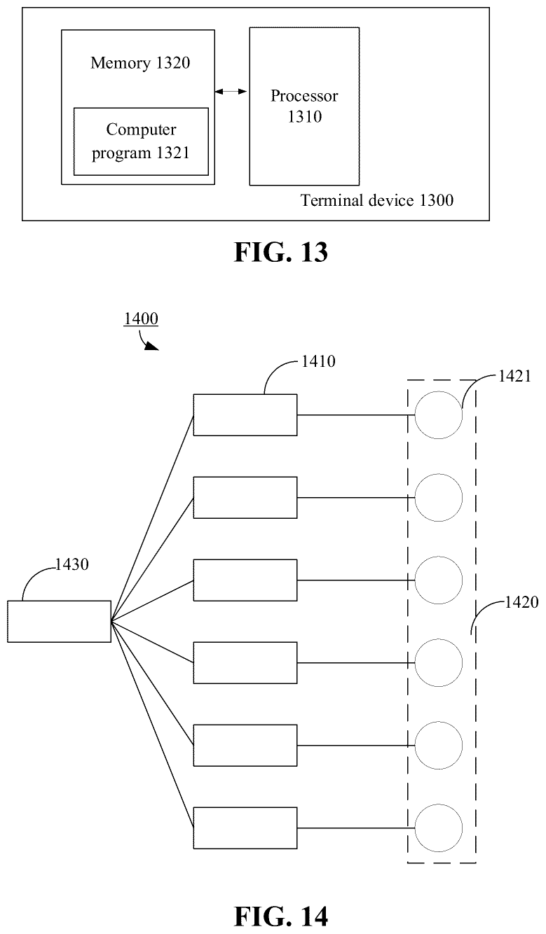

FIG. 13 is a structural block diagram of an exemplary terminal device 1300 according to some embodiments of the present disclosure. For ease of explanation, only parts related to the embodiments of the present disclosure are shown.

As shown in FIG. 13, terminal device 1300 includes: at least one processor 1310 (only one is shown in FIG. 13), a memory 1320 coupled to processor 1310, and a computer program 1321 stored in memory 1320 and capable of running on at least one processor 1310, for example a sensing program of a sensing system. When the processor 1310 executes the computer program 1321, the steps in each embodiment of a sensing method for sensing system are implemented, for example, the steps S801 and S802 as shown in FIG. 8, or the steps S901 and S902 as shown in FIG. 9.

In some embodiments, computer program 1321 can be divided into one or more modules, and the one or more modules are stored in the memory 1320 and executed by the processor 1310 to implement the present disclosure. The one or more modules may be a series of computer program instruction segments capable of completing specific functions, and the instruction segments are used to describe the execution process of the computer program 1321 in terminal device 1300.

Terminal device 1300 may include, but is not limited to, processor 1310 and memory 1320. Those skilled in the art can understand that FIG. 13 is only an example of terminal device 1300 and does not constitute a limitation on terminal device 1300. Terminal device 1300 may include more or less components than shown in the figure, or some combination of components, or different components, for example, it may also comprise input/output devices, network access devices, buses, etc.

Processor 1310 may be a central processing unit (CPU). Processor 1310 may also be other general-purpose processors, digital signal processors (DSP), application specific integrated circuits (ASIC), field-programmable gate arrays (FPGA) or other programmable logic devices, discrete gate or transistor logic devices, discrete hardware components, etc. A general-purpose processor may be a microprocessor, or the processor may be any conventional processor, etc.

Memory 1320 may be an internal storage unit of terminal device 1300, such as a hard disk or memory of terminal device 1300. Memory 1320 may also be an external storage device of terminal device 1300, such as a plug-in hard disk, a smart media card (SMC), a secure digital (SD) card, or a flash card equipped on terminal device 1300. Further, memory 1320 may also comprise both an internal storage unit of terminal device 1300 and an external storage device. Memory 1320 is used to store operating systems, application programs, boot loaders, data, and other programs, such as program codes of the computer program. Memory 1320 can also be used to temporarily store data that has been output or is to be output.

When an existing LiDAR performs target detection, the size of light spots formed by the light emitted by the LiDAR are generally fixed. In target detection, light spots with a fixed size cannot adapt well to the current detected target, which will affect the signal strength of the received reflected light, thereby affecting the accuracy of target detection.

Embodiments of the present disclosure further provides a target detection method that uses OPA LiDAR to adjust the input light so that the light emitted by each antenna sub-array of OPA LiDAR forms a light spot at a preset position. The light spots are combined according to present rules to obtain a light spot combination, so that light spot combinations of different shapes and sizes can be obtained. Target detection is performed based on the light spot combination, so that the size and shape of the light spot combination can be adjusted during the process of target detection to make the light spot combination adapt to the target, thereby improving the accuracy of target detection.

The target detection method provided in embodiments of the present disclosure is applied to an OPA LiDAR. FIG. 14 is a schematic diagram of an exemplary OPA LiDAR 1400, according to some embodiments of the present disclosure. As shown in FIG. 14, OPA LiDAR 1400 includes a plurality of phase modulators 1410, a phased array antenna 1420, and a laser 1430. Phased array antenna 1420 includes a plurality of antennas 1421, and a preset number of antennas 1421 form an antenna sub-array. The plurality of antennas 1421 in an antenna sub-array can be adjacent in sequence or distributed at intervals. The plurality of phase modulators 1410 are connected to the plurality of antennas 1421 in the antenna sub-array, and one antenna 1421 corresponds to one phase modulator 1410. The light emitted by laser 1430 is input into each phase modulator 1410 through optical waveguide. The plurality of phase modulators 1410 are used to adjust the input light to change the phase of the light emitted by the corresponding antenna 1421, and in an antenna sub-array, the phase difference between two adjacent antennas 1421 is the same.

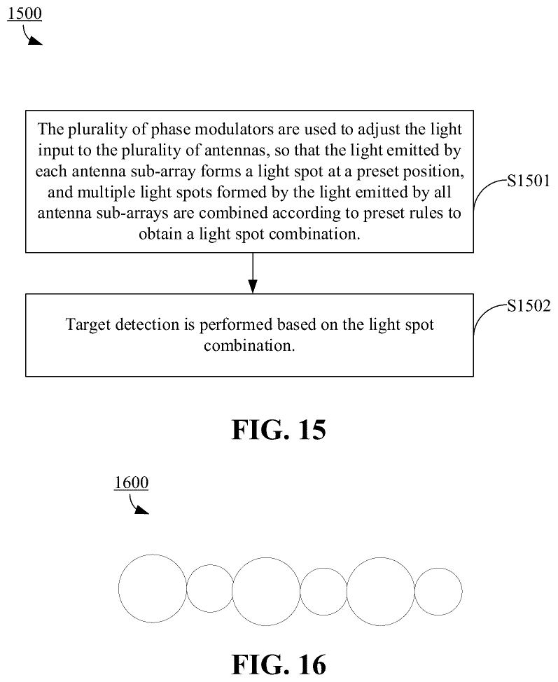

FIG. 15 shows a flow chart of an exemplary target detection method 1500, according to some embodiments of the present disclosure. As shown in FIG. 15, target detection method 1500 includes steps S1501 and S1502.

At step S1501, the plurality of phase modulators are used to adjust the light input to the plurality of antennas, so that the light emitted by each antenna sub-array forms a light spot at a preset position, and multiple light spots formed by the light emitted by all antenna sub-arrays are combined according to preset rules to obtain a light spot combination.

The OPA LiDAR includes a processor, and target detection method 1500 is executed by the processor.

In some embodiments, the preset position is a position where target detection is required. The light emission angle is determined according to the position where target detection is required, the phase of the light input to each antenna is determined based on the light emission angle, and the plurality of phase modulators are used to correspondingly adjust the phase of the light input in each antenna, so that the light spot formed by the light emitted by each antenna sub-array is located at the preset position. Therefore, the accuracy of target detection is improved. By adjusting the phase difference corresponding to each antenna sub-array, the antenna sub-arrays can form light spots at the same position. Since the total energy of light emitted by all antenna sub-arrays is fixed, if each antenna sub-array forms a light spot at the same position, the energy of the light spots will be the largest; if each antenna sub-array forms a light spot at different positions, the energy of the emitted light is dispersed in each light spot.

In some embodiments, each phase modulator is controlled to adjust the phase of the light input to each antenna according to the position where target detection is required, so that the phase difference corresponding to each antenna sub-array changes according to a preset cycle, as a result the corresponding light spot of each antenna sub-array changes position according to the preset cycle, so as to realize the scanning of the position where target detection is required.

In some embodiments, the position of the light spot corresponding to each antenna sub-array can also be changed by adjusting the frequency of the light input to the antennas.

The size of the light spot is related to the number of antennas in the corresponding antenna sub-array. The more antennas in the antenna sub-array, the smaller the light spot. In some embodiments, the number of antennas in each antenna sub-array is determined based on the preset size of light spot. The preset size of light spot may be set by the user, or may be determined by the processor based on the target detection scenario.

The number of antennas in each antenna sub-array may be the same or different. If the number of antennas in each antenna sub-array is the same, the size of each light spot will be the same. If the number of antennas in each antenna sub-array is different, the size of each light spot will be different.

The light spots formed by multiple antenna sub-arrays are combined according to preset rules to obtain a light spot combination, and each light spot in the light spot combination may or may not overlap with other light spots.

In some embodiments, compared with the light spots corresponding to other antenna sub-arrays, the light spot corresponding to the antenna sub-array with the smallest number of antennas is the largest, the energy of the light spot is the smallest, and the energy of the reflected light at the position of the light spot is also smaller. The light spot corresponding to the antenna sub-array with the smallest number of antennas overlap with the light spots corresponding to other sub-arrays, to avoid the position where the energy of light spot is small, and thus avoid receiving the signal of weak reflected light and improve the accuracy of target detection.

In some embodiments, the light spots corresponding to the antenna sub-arrays other than the antenna sub-array with the smallest number of antennas do not overlap, so that the size of the light spot can be increased, thereby increasing the target detection range.

At step S1502, target detection is performed based on the light spot combination.

Specifically, the light emitted by each antenna sub-array hits at a preset position to form a light spot combination, the processor analyzes the light reflected from the preset position to the OPA LiDAR to determine the position or speed of the detected target.

In the aforesaid embodiments, the plurality of phase modulators are used to adjust the input light, so that the light emitted by each antenna sub-array forms a light spot at a preset position, and multiple light spots formed all antenna sub-arrays are combined according to the preset rules to obtain a light spot combination. Since the light spot combination is obtained by combining multiple light spots, the size and shape of the light spot combination can be adjusted by adjusting the size and position of each light spot. Then target detection is performed based on the light spot combination, so that light spot combinations of different sizes and shapes can be used for target detection to make the light spot combination adapt to the target that needs to be detected, thereby improving the accuracy of target detection.

In some embodiments, the preset pattern of light spot combination is determined first, then the number of antennas in each antenna sub-array and the phase of the light input to each antenna are determined according to the preset pattern of light spot combination. The pattern of the light spot combination includes a size and a shape of the light spot combination.

FIG. 16 is a schematic diagram of an exemplary light spot combination 1600, according to some embodiments of the present disclosure. In some embodiments, as shown in FIG. 16, the preset pattern 1600 of light spot combination is that large light spots are adjacent to small light spots. Performing target detection based on this light spot combination can increase the detection range while preventing light spots with small energy from being concentrated in one position, thereby improving the accuracy of target detection. According to the preset pattern of light spot combination, it is determined that in a first group of antenna sub-arrays, the number of antennas in each antenna sub-array is a first number, and in a second group of antenna sub-arrays, the number of antennas in each antenna sub-array is a second number. The first number is greater than the second number. Then, the light spot corresponding to an antenna sub-array with the first number of antennas is a small light spot, and the light spot corresponding to an antenna sub-array with the second number of antennas is a large light spot. The position of the large light spot and the position of the small light spot are determined according to the position where target detection is required. According to the position of the large light spot and the position of the small light spot, the plurality of phase modulators are used to adjust the input light so that the light spot corresponding to the antenna sub-array with the first number of antennas is adjacent to the light spot corresponding to the antenna sub-array with the second number of antennas, and a light spot combination as shown in FIG. 16 can be obtained.

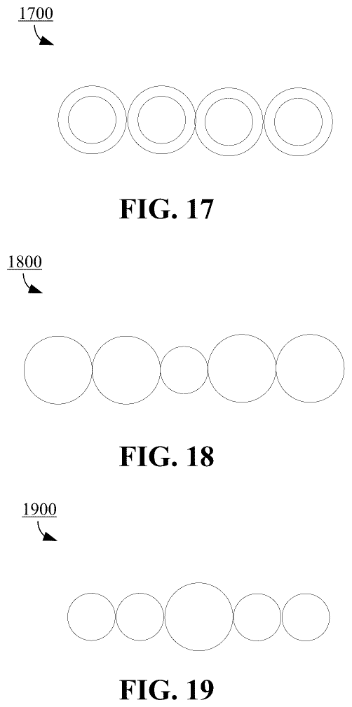

FIG. 17 is a schematic diagram of another exemplary light spot combination 1700, according to some embodiments of the present disclosure. In some embodiments, as shown in FIG. 17, the preset pattern 1700 of light spot combination is such that each small light spot is located within a large light spot, thereby preventing weak signal of the reflected light corresponding to the position of the large light spot and improving the accuracy of target detection. According to the preset pattern 1700 of light spot combination, it is determined that in a first group of antenna sub-arrays, the number of antennas in each antenna sub-array is the first number, and in a second group of antenna sub-arrays, the number of antennas in each antenna sub-array is the second number. The first number is greater than the second number. Then, the light spot corresponding to an antenna sub-array with the first number of antennas is a small light spot, and the light spot corresponding to an antenna sub-array with the second number of antennas is a large light spot. The position of the large light spot and the position of the small light spot are determined according to the position where target detection is required. According to the position of the large light spot and the position of the small light spot, the plurality of phase modulators are used to adjust the input light so that the light spot corresponding to the antenna sub-array with the first number of antennas overlaps with the light spot corresponding to the antenna sub-array with the second number of antennas, and a light spot combination as shown in FIG. 17 can be obtained.

FIG. 18 is a schematic diagram of another exemplary light spot combination 1800, according to some embodiments of the present disclosure. In some embodiments, it is determined that in a first group of antenna sub-arrays, the number of antennas in each antenna sub-array is the first number, and in a second group of antenna sub-arrays, the number of antennas in each antenna sub-array is the second number. If the first number is greater than the second number, the light spot corresponding to an antenna sub-array with the first number of antennas is a small light spot, and the light spot corresponding to an antenna sub-array with the second number of antennas is a large light spot. The plurality of phase modulators are used to adjust the input light so that the light spot corresponding to the antenna sub-array with the first number of antennas is located in the middle position, the light spots corresponding to the antenna sub-arrays with the second number of antennas are located at both sides, and a light spot combination as shown in FIG. 18 can be obtained, that is, the small light spot is located in the middle and the large light spots are located at both sides. Using the light spot combination shown in FIG. 18 for target detection can expand the range of target detection.

FIG. 19 is a schematic diagram of another exemplary light spot combination 1900, according to some embodiments of the present disclosure. If the first number is smaller than the second number, the light spot corresponding to an antenna sub-array with the first number of antennas is a large light spot, and the light spot corresponding to an antenna sub-array with the second number of antennas is a small light spot. The plurality of phase modulators are used to adjust the input light so that the light spot corresponding to the antenna sub-array with the first number of antennas is located in the middle position, the light spots corresponding to the antenna sub-arrays with the second number of antennas are located at both sides, and a light spot combination as shown in FIG. 19 can be obtained, that is, the large light spot is located in the middle and the small light spots are located at both sides, thereby preventing the weak signal of the light reflected in the edge area.

It should be noted that depending on the position where target detection is required or the scenario of target detection, the combined light spots can also be in other patterns. For example, in the combined light spots, the light spots may be arranged horizontally or vertically. The size of the light spots in the combined light spots can be divided into three types: large, medium, small, or more types, etc.

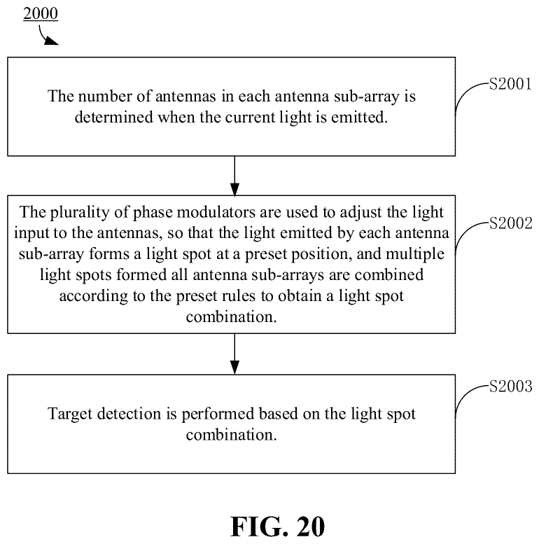

FIG. 20 is a flow chart of another target detection method 2000, according to some embodiments of the present disclosure. As shown in FIG. 20, target detection method 2000 includes steps S2001 to S2003.

At step S2001, the number of antennas in each antenna sub-array is determined when the current light is emitted.

Target detection method 2000 provided in embodiments of the present disclosure is applied to an OPA LiDAR. The OPA LiDAR includes a plurality of phase modulators and a phased array antenna, the phased array antenna includes multiple antenna sub-arrays. The plurality of phase modulators are coupled to the antennas in the antenna sub-arrays, and one phase modulator is connected to one antenna.

The number of antennas in each antenna sub-array changes dynamically, and the number of antennas in each antenna sub-array when the current light is emitted is determined according to the pattern of the currently required light spot combination. The pattern of the currently required light spot combination is determined based on the current target detection requirements. For example, if it is determined that long-distance target detection is currently being carried out, all antennas in the OPA LiDAR form an antenna sub-array. If it is determined that a small target needs to be detected, the light spot combination is determined to be a large light spot, and the number of antennas in each antenna sub-array is reduced. After determining the number of antennas in each antenna sub-array, the phase of the light input to antennas is adjusted so that in the same antenna sub-array, the phase difference between two adjacent antennas is the same.

In some embodiments, whether to divide the phased array antenna into antenna sub-arrays is determined first. If it is needed to divide the phased array antenna into antenna sub-arrays, the number of antennas in each antenna sub-array is determined. If it is not needed to divide the phased array antenna into antenna sub-arrays, in the phased array antenna, the phase difference between two adjacent antennas is the same. For example, if it is determined that the current target is large based on the signal of reflected light from the target, it is determined not to divide the phased array antenna into antenna sub-arrays; if it is determined that the current target is small based on the signal of reflected light from the target, it is determined to divide the phased array antenna into antenna sub-arrays. By determining whether to divide the phased array antenna into antenna sub-arrays, the light spot formed by the light emitted by the phased array antenna can be dynamically adjusted so that the light spot is adapted to the target that needs to be detected.

At step S2002, the plurality of phase modulators are used to adjust the light input to the antennas, so that the light emitted by each antenna sub-array forms a light spot at a preset position, and multiple light spots formed all antenna sub-arrays are combined according to the preset rules to obtain a light spot combination.

At step S2003, target detection is performed based on the light spot combination.

Steps S2002 and S2003 are the same as steps S1501 and S1502 in target detection method 1500 shown in FIG. 15, and will not be described again here.

In some embodiments, when performing target detection, first the number of antennas in each antenna sub-array is determined when the current light is emitted, and then phase modulators are used to adjust the light input to the antennas, so that the light emitted by each antenna sub-array forms a light spot at the preset position to obtain a light spot combination, and target detection is performed based on the light spot combination. Therefore, during the target detection process, the pattern of the light spot combination can be adjusted at any time according to actual needs, making target detection adaptable to a variety of scenarios.

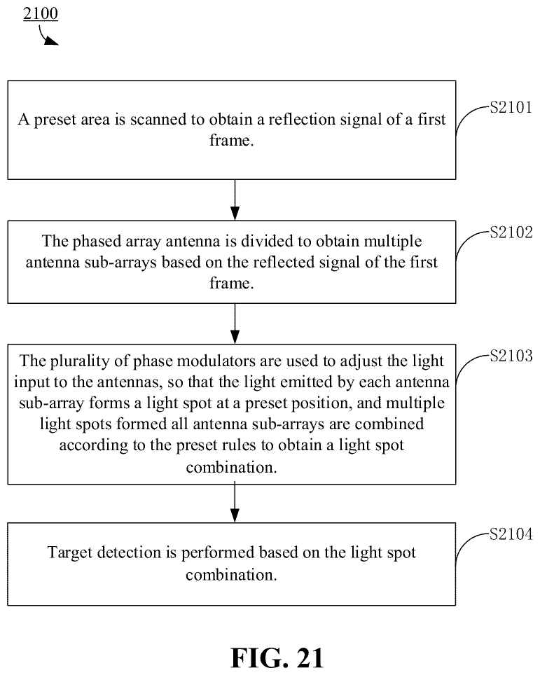

FIG. 21 is a flow chart of another target detection method 2100, according to some embodiments of the present disclosure. As shown in FIG. 21, target detection method 2100 includes steps S2101 to S2104.

At step S2101, a preset area (i.e., a preset scanning area) is scanned to obtain a reflection signal of a first frame. The reflection signal of the first frame is obtained by detecting the light reflected by the preset area.

Target detection method 2100 provided in embodiments of the present disclosure is applied to an OPA LiDAR. The OPA LiDAR includes a plurality of phase modulators and a phased array antenna. The phased array antenna includes multiple antenna sub-arrays. The plurality of phase modulators are coupled to the antennas in the antenna sub-arrays, and one phase modulator is connected to one antenna.

The light emitted by each antenna sub-array scans the preset area, and after the transmission signal of the first frame is emitted, the reflected signal of the first frame is correspondingly received.

At step S2102, the phased array antenna is divided to obtain multiple antenna sub-arrays based on the reflected signal of the first frame.

Specifically, the target information in the preset area is determined based on the reflected signal of the first frame, the number of antenna sub-arrays and the number of antennas in each antenna sub-array are determined based on the target information. The phased array antenna is divided to obtain multiple antenna sub-arrays based on the number of antenna sub-arrays and the number of antennas in each antenna sub-array. The target information can be the general outline of the target, the arrangement rules of the target, the distribution position of the target, and other information.

In some embodiments, the arrangement and combination of the light spots corresponding to each antenna sub-array are determined based on the target information corresponding to the reflected signal of the first frame, and the arrangement and combination of the light spots includes the number and relative position arrangement of the light spots. After obtaining the arrangement and combination of light spots, the number of antenna sub-arrays and the number of antennas in each antenna sub-array are determined, and the phased array antenna is divided according to the number of antenna sub-arrays and the number of antennas in each antenna sub-array to obtain multiple antenna sub-arrays. The phase difference corresponding to each antenna sub-array is determined based on the position of each light spot. Then the phase adjustment information of phase modulators is determined based on the phase difference corresponding to each antenna sub-array. Determining the arrangement and combination of light spots through the target information can make the subsequently obtained light spot combination adapt to the target information and improve the accuracy of target detection.

At step S2103, the phase modulators are used to adjust the light input to the antennas, so that the light emitted by each antenna sub-array forms a light spot at a preset position, and multiple light spots formed all antenna sub-arrays are combined according to the preset rules to obtain a light spot combination.

At step S2104, target detection is performed based on the light spot combination.

Steps S2103 and S2104 are the same as steps S1501 and S1502 in target detection method 1500 shown in FIG. 15, and will not be described again here.

In the aforesaid embodiments, the reflected signal of the first frame is obtained by scanning the preset area, the phased array antenna is divided based on the reflection signal of the first frame to obtain multiple antenna sub-arrays, the phase modulators are used to adjust the light input to the antennas, so that the light emitted by each antenna sub-array forms a light spot at a preset position to obtain a light spot combination, and target detection is performed based on the light spot combination. Since the reflection signal of the first frame contains information of the preset area, after obtaining the information of the preset area, determining the pattern of the light spot combination can improve the accuracy of target detection.

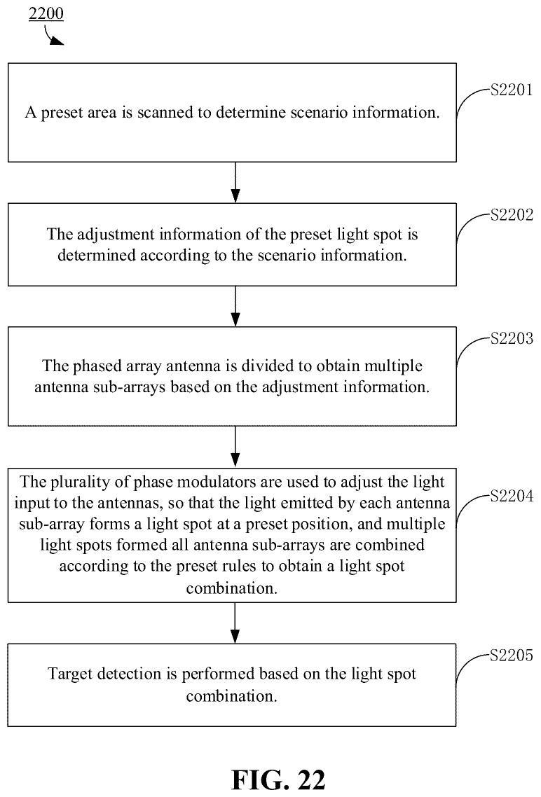

FIG. 22 is a flow chart of another target detection method 2200, according to some embodiments of the present disclosure. As shown in FIG. 22, target detection method 2200 includes steps S2201 to S2205.

At step S2201, a preset area is scanned to determine scenario information.

Specifically, the light emitted by each antenna scans the preset area, and the scenario information is determined based on the received corresponding reflected light.

In some embodiments, if it is determined that the target cannot be detected based on the reflected light corresponding to the preset area, the scenario information is determined to be a scenario of long-distance detection. Specifically, when the beam emitted by the antenna is irradiated at a long distance, the point cloud density of the light spot formed on the obstacle becomes smaller and the angular resolution is reduced, resulting in a situation where the target cannot be detected. For example, when the OPA LiDAR on a vehicle performs target detection on the highway, it cannot detect roadblocks or other vehicles that are far away from the vehicle. Therefore, if it is determined that the target cannot be detected based on the reflected light corresponding to the preset area, it means that the target is far away from the OPA LiDAR, and the scenario information is determined to be a scenario of long-distance detection.

In some embodiments, if it is determined based on the reflected light corresponding to the preset area that the intensity difference of the reflected signals in different frames is greater than the preset difference, the scenario information is determined to be a scenario of specular reflection. Specifically, when the light emitted by the antenna hits a plane with high reflectivity such as glass, the light may be reflected in various directions, and the reflected light is detected to obtain the reflected signal of each frame. Among the reflected signals of various frames, there will be reflected signals with lower intensity. For example, during the target detection process, there will be a cycle or area where the target can be detected, but the reflected signal is abnormal. Signal abnormality means that the reflected signal cannot be received, or the strength of the reflected signal is less than the preset value. Therefore, if it is determined based on the reflected light corresponding to the preset area that the intensity difference of the reflection signals in different frames is greater than the preset difference, it means there is a target and the strength of reflected signals of the target is unstable, and the scenario information is determined to be a scenario of specular reflection.

In some embodiments, if it is determined based on the reflected light corresponding to the preset area that there are light spots that cannot hit the target, the scenario information is determined to be a scenario of small target. Specifically, when the light emitted by the antenna hits a slender target, laser spots are formed on the target. If the target is moving or the OPA LiDAR is moving, and the laser spots are arranged along the length of the target, there will be a situation where the emitted light cannot reach the target. For example, an OPA LiDAR is installed on a vehicle. When the vehicle is driving, if the light emitted by the antenna shines on slender targets such as telephone poles and speed poles, in the different cycles of target detection, there will be the situation that the targets are detected and the situation that the targets are not detected. Therefore, if it is determined based on the reflected light corresponding to the preset area that there is a light spot that cannot hit the target, it means that the target is small, and the scenario information is determined to be a scenario of small target.

At step S2202, the adjustment information of the preset light spot is determined according to the scenario information.

The adjustment information may be information indicating the shape and size of the light spot, or information indicating the increase or decrease of the light spot.

In some embodiments, if the current scenario information is a scenario of long-distance detection, the adjustment information is determined to increase the light spot, so as to increase the coverage area of the light spot and increase the probability of receiving reflected light, thereby improving the accuracy of target detection.

In some embodiments, if the current scenario information is a scenario of specular reflection, the adjustment information is determined to increase the light spot, so as to increase the coverage area of a single emission point, increase the possibility of the light spot illuminating the diffuse reflection surface, and improve the intensity of the reflected light received, thereby improving the accuracy of target detection.

In some embodiments, if the current scenario information is a scenario of small target, the adjustment information is determined to increase the light spot. Wherein, the adjustment information may also include the direction in which the light spot increases, that is, the light spot increases in the transverse direction of the target, so that the light spot can hit the target, thus improving the accuracy of target detection.

At step S2203, the phased array antenna is divided to obtain multiple antenna sub-arrays based on the adjustment information.

Specifically, according to the adjustment information, the size of each light spot in the light spot combination hitting the target is determined, and according to the size of each light spot, the number of antenna sub-arrays and the number of antennas in each antenna sub-arrays are determined.

At step S2204, the phase modulators are used to adjust the light input to the antennas, so that the light emitted by each antenna sub-array forms a light spot at a preset position, and multiple light spots formed all antenna sub-arrays are combined according to the preset rules to obtain a light spot combination.

At step S2205, target detection is performed based on the light spot combination.

Steps S2204 and S2205 are the same as steps S1501 to S1502 in target detection method 1500 shown in FIG. 15, and will not be described again here.

In the aforesaid embodiments, the scenario information is determined by scanning the preset area, the adjustment information of preset light spots is determined according to the scenario information, phased array antenna is divided based on the scenario information to obtain multiple antenna sub-arrays, the phase modulators are used to adjust the light input to the antennas, so that the light emitted by each antenna sub-array forms a light spot at a preset position to obtain a light spot combination, and target detection can be performed based on the light spot combination, so as to obtain the light spot combination matching the scenario information, thereby improving the accuracy of target detection.

It should be understood that the sequence number of each step in the aforesaid embodiments does not mean the order of execution. The execution order of each process shall be determined by its function and internal logic, and shall not constitute any limitation on the implementation process of the embodiments of the present application.

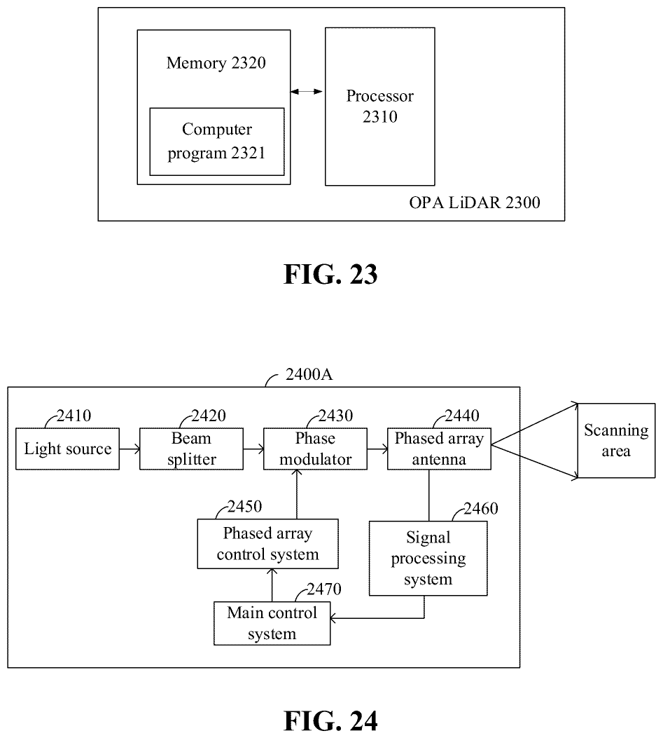

FIG. 23 is a structural block diagram of an exemplary OPA LiDAR 2300, according to some embodiments of the present disclosure. As shown in FIG. 23, OPA LiDAR 2300 includes a processor 2310, a memory 2320, and a computer program 2321 stored in the memory 2320 and capable of running on the processor 2310. When the processor 2310 executes the computer program 2321, the steps in the aforesaid embodiments of the target detection methods, such as steps S1501 and S1502 shown in FIG. 15, or steps S2001 to S2003 shown in FIG. 20, or steps S2101 to S2104 shown in FIG. 21, or steps S2201 to S2205 shown in FIG. 22.

In some embodiments, computer program 2321 can be divided into one or more modules/units, and the one or more modules/units are stored in the memory 2320 and executed by the processor 2310 to implement the present application. The one or more modules/units may be a series of computer program instruction segments capable of completing specific functions, and the instruction segments are used to describe the execution process of the computer program 2321 in the OPA LiDAR.

Those skilled in the art can understand that FIG. 23 is only an example of the OPA LiDAR and does not constitute a limitation on the OPA LiDAR. The OPA LiDAR may include more or less components than shown in the figure, or some combination of components, or different components, for example, the OPA LiDAR may also comprise input/output devices, network access devices, buses, etc.

Processor 2310 may be a central processing unit (CPU), and may also be other general-purpose processors, digital signal processors (DSP), application specific integrated circuits (ASIC), field-programmable gate arrays (FPGA) or other programmable logic devices, discrete gate or transistor logic devices, discrete hardware components, etc. A general-purpose processor may be a microprocessor, or the processor may be any conventional processor, etc.

Memory 2320 may be an internal storage unit of the OPA LiDAR, such as a hard disk or memory of the OPA LiDAR. Memory 2320 may also be an external storage device of the OPA LiDAR, such as a plug-in hard disk, a smart media card (SMC), a secure digital (SD) card, or a flash card equipped on the OPA LiDAR. Further, memory 2320 may also comprise both an internal storage unit and an external storage device of the OPA LiDAR. Memory 2320 is used to store the computer program and other programs and data required by the OPA LiDAR. Memory 2320 can also be used to temporarily store data that has been output or is to be output.

During the scanning by a LiDAR on objects on the road surface or in the front scanning area, if there are obstacles, isolated points will be formed in the scanned point cloud. In addition, noisy points may exist during the scanning process due to the system defect, and noisy points will also form isolated points in the scanned point cloud. However, the current LiDAR cannot effectively identify whether the isolated points in the scanned image are actual obstacles or noisy points caused by the system itself, thus leading to misjudgment, and misjudgment may result in traffic accidents.

Embodiments of the present disclosure further provide an OPA LiDAR and method for identifying noisy points.

FIG. 24 is a structural block diagram of an exemplary OPA LiDAR 2400A, according to some embodiments of the present disclosure. As shown in FIG. 24, OPA LiDAR 2400A includes a light source 2410, a beam splitter 2420, a phase modulator 2430, a phased array antenna 2440, a phased array control system 2450, a signal processing system 2460, and a main control system 2470.

Light source 2410 is configured to output optical signals.

Beam splitter 2420 is coupled to the light source 2410 and is configured to split the optical signals output by light source 2410.

Phase modulator 2430 is coupled to beam splitter 2420 and is configured to modulate the phase of the optical signals input to phased array antenna 2440.

Phased array antenna 2440 is coupled to the phase modulator 2430 and is configured to emit split optical signals into space as detection light detection light, the detection light can form a scanning light spot in space. Phased array antenna 2440 is further configured to receive reflected echoes in space.

Phased array control system 2450 is coupled to phase modulator 2430 and is configured to adjust the emission angle and emission direction of the detection light to adjust the formation position of the scanning light spot.

Signal processing system 2460 is coupled to phased array antenna 2440 and is configured to process the reflected echoes and obtain corresponding electrical signals.

Main control system 2470 is coupled to phased array control system 2450 and signal processing system 2460 respectively, and is configured to calculate a distance and speed of the target object in the scanning area based on the electrical signals. The distance refers to a distance between the target object and the OPA LiDAR. Main control system is also configured to send feedback adjustment instructions to phased array control system 2450 when there are suspected noisy points in the scanning area so as to adjust the emission angle and direction of the scanning detection light, increase the angular resolution, and scan the adjacent area of suspected noisy points.

In some embodiments of the present disclosure, light source 2410 may be a semiconductor light source. Beam splitter 2420 can split the input light. Signal processing system 2460 can be configured to convert the reflected echoes, including photoelectric detection, signal filtering, amplification, acquisition and other processing, and then obtain electrical signals corresponding to the reflected echoes. Main control system 2470 is configured to calculate a distance and speed of the target object in the scanning area based on the electrical signals, which can be implemented based on existing algorithms, and will not be described in detail here.

When main control system 2470 determines that there are suspected noisy points in the scanning area, a feedback command is sent to phased array control system 2450 to adjust the emission angle and direction of the detection light so that the scanning light spot can hit the adjacent area of the suspected noisy points and the adjacent area of the suspected noisy points can be scanned. Furthermore, increasing the angular resolution improves the scanning accuracy and allows for clearer scanning of the adjacent area of the suspected noisy points.

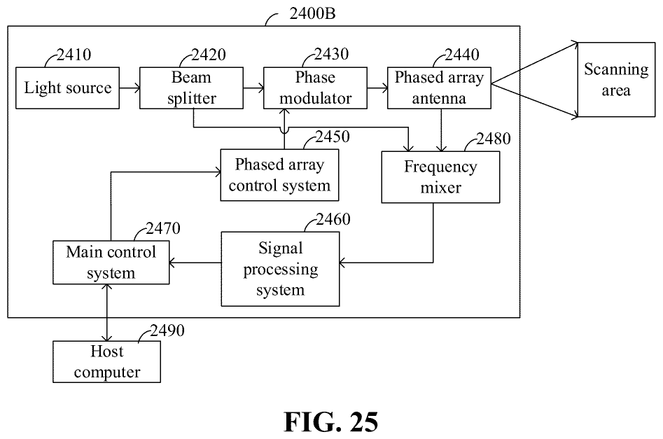

FIG. 25 is a structural block diagram of another exemplary OPA LiDAR 2400B, according to some embodiments of the present disclosure. In this implementation, when the laser emitted by OPA LiDAR 2400B, i.e., optical signals output by light source 2410, is a frequency modulated continuous wave, OPA LiDAR 2400B further includes a frequency mixer 2480.

Frequency mixer 2480 is coupled to beam splitter 2420 and phased array antenna 2440 respectively, and is configured to mix the reflected echoes and the reference light to obtain difference frequency optical signals.

Correspondingly, signal processing system 2460 is coupled to frequency mixer 2480 and is configured to process the difference frequency optical signals output by frequency mixer 2480 to obtain electrical signals corresponding to the difference frequency optical signals.

The optical signals output by light source 2410 can be split by beam splitter 2420, and then the reference light and the detection light can be output respectively.

OPA laser radar system 2400 may further includes a host computer 2490.

Host computer 2490 is communicatively coupled with main control system 2470. Host computer 2490 is configured to form a first point cloud with a first scanning resolution and a second point cloud with a second scanning resolution based on the distance and speed.

Specifically, host computer 2490 is also configured to determine whether the suspected noisy points are noisy points based on the second point cloud with the second scanning resolution. The method of determining whether suspected noisy points are noisy points based on the second point cloud with the second scanning resolution will be described later.

The OPA LiDAR provided in the present disclosure can adjust the emission angle and direction of the detection light through the phased array control system to realize the adjustment of the formation position of the scanning light spot. When there are noisy points, the emission angle and direction of the scanning detection light can be adjusted, and the angular resolution is increased, the adjacent area of the suspected noisy points is scanned, thereby whether the suspected noisy points are noisy points or real obstacles are effectively identified. Therefore, the problem that currently a LiDAR cannot effectively identify whether the isolated points in the scanning point cloud are actual obstacles or noisy points caused by the system itself can be resolved, and the measurement accuracy of LiDAR is improved.

Based on OPA LiDAR 2400A (FIG. 24) and OPA LIDAR 2400B (FIG. 25), a method for identifying noisy points of an OPA LiDAR is provided the embodiments of the present disclosure.

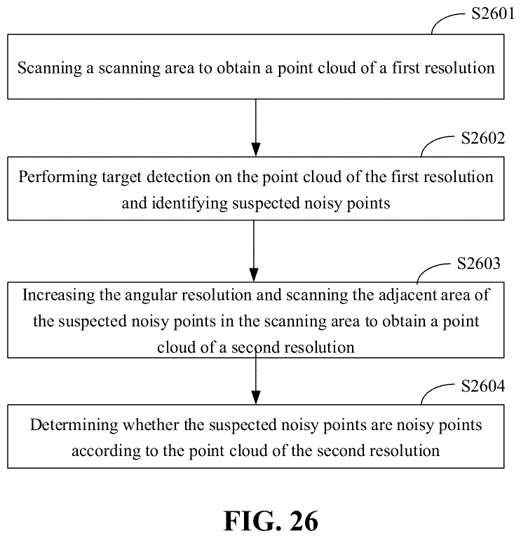

FIG. 26 shows a flow chart of an exemplary method 2600 for identifying noisy points of an OPA LiDAR, according to some embodiments of the present disclosure. As shown in FIG. 26, method 2600 for identifying noisy points of an OPA LiDAR includes steps S2601 to S2604.

At step S2601, a scanning area (e.g., preset scanning area) is scanned to obtain a point cloud with a first scanning resolution.

In some embodiments, the phased array antenna (e.g., phase array antenna 2440 in FIGS. 24 and 25) of the OPA LiDAR is controlled to emit detection light to scan the scanning area and receive reflected echoes, and a first point cloud with the first scanning resolution is obtained based on the reflected echoes.

At step S2602, target detection is performed on the first point cloud with the first scanning resolution and identifying suspected noisy points.

In some embodiments, the first point cloud with the first scanning resolution is detected for isolated points. If there are isolated points, the isolated points are identified as suspected noisy points.

At step S2603, the angular resolution (i.e., scanning resolution) is increased and scanning the adjacent area (e.g., a fine scanning area) of the suspected noisy points in the scanning area to obtain a second point cloud with a second scanning resolution.

In some embodiments, after suspicious noisy points are detected, feedback instructions are sent to the phased array control system through the main control system (e.g., main control system 2470 shown in FIGS. 24 and 25) of the OPA LiDAR to adjust the emission angle and emission direction of the scanning detection light, increase the angular resolution, and scan the adjacent area of suspected noisy points.

In some embodiments, step S2603 may specifically include the following steps: determining the adjacent area of suspected noisy points; and increasing the angular resolution and adjust the scanning direction to scan the adjacent area of the suspected noisy points.

In some embodiments, the adjacent point cloud area of suspected noisy points can be determined as the adjacent area of suspected noisy points. The adjacent area of suspected noisy points contains the location of the suspected noisy points.

In some embodiments, the angular resolution of the OPA LiDAR is improved, and then the phased array antenna is controlled by the phased array control system to adjust the scanning direction, so that the OPA LiDAR can scan adjacent area of suspected noisy points with higher angular resolution and receive the reflected echoes, and obtain the second point cloud with the second scanning resolution based on the reflected echoes.

At step S2604, whether the suspected noisy points are noisy points are determined according to the second point cloud with the second scanning resolution.

In some embodiments, the second point cloud with the second scanning resolution can accurately reflect the scenario of adjacent area of the suspicious noisy points. If the suspicious noisy points still exist in the second point cloud with the second scanning resolution, it means that they are existing obstacles in the scanning area, i.e., non-noisy points. If the suspected noisy points do not exist in the second point cloud with the second scanning resolution, it means that they are system noise of the OPA LiDAR, i.e., noisy points.

In some embodiments, steps S2604 may specifically include the following steps: performing target detection on the second point cloud with the second scanning resolution; and if the detection result of target detection contains contour information, the suspected noisy points determined to be non-noisy points, otherwise the suspected noisy points are determined to be noisy points.

Specifically, if the detection result of the target detection is that no target is detected, or the detection result does not contain contour information, the suspected noisy points are determined to be noisy points.

In some embodiments, target detection on the second point cloud with the second scanning resolution can be implemented based on existing algorithms, which will not be described in detail in the present disclosure.

If the detection result of target detection contains contour information, it means that there are actual obstacles at the location of the suspicious noisy points. If the detection result of target detection is that no target is detected, or the detection result does not contain contour information, then the suspicious noisy points are system noise of the OPA LiDAR, i.e., noisy points.

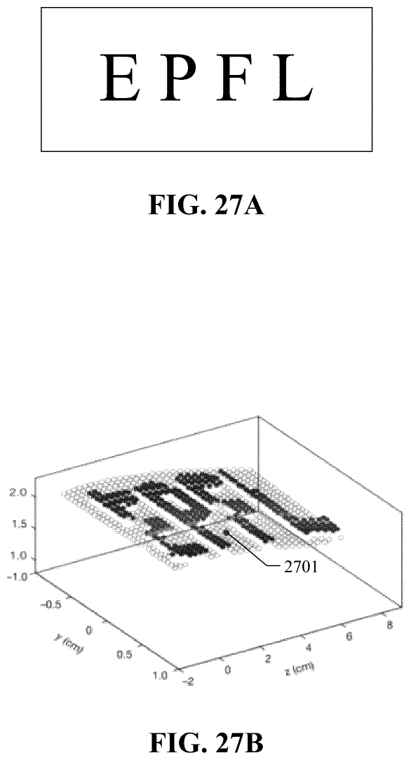

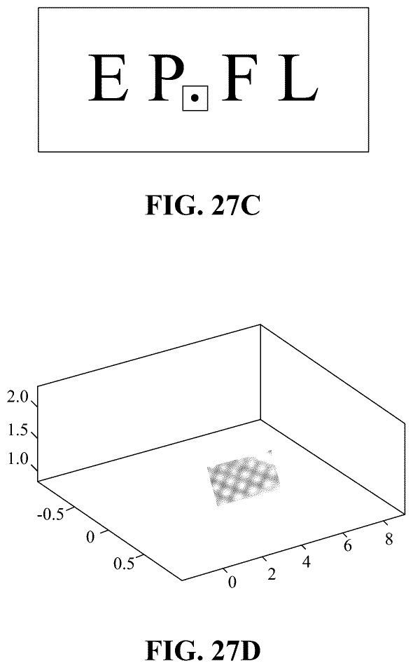

In order to more intuitively describe the beneficial effects of the method for identifying noisy points provided by the embodiments of the present disclosure, FIGS. 27A-27D illustrate diagrams of exemplary application scenario of the method for identifying noisy points, according to some embodiments of the present disclosure.

Referring to FIGS. 27A-27D, FIG. 27A illustrates a scanning area, where there are four letters making up “EPFL” in the scanning area, and there are no stray objects below the letter P. FIG. 27B illustrates a first point cloud with a first scanning resolution obtained by scanning the scanning area using an OPA LiDAR. As can be seen from FIG. 27B, there is an abnormal isolated point 2701 (i.e., a suspected noisy point) below the letter P. By adjusting the OPA LiDAR to increase the resolution and adjust the scanning direction, the adjacent area of the suspected noisy point (the rectangular area in FIG. 27C) is rescanned to obtain a second point cloud with a second scanning resolution as shown in FIG. 27D.

As can be seen from FIG. 27D, there is no detection target in the second point cloud with the second scanning resolution, so the suspected noisy point is determined to be a noisy point.

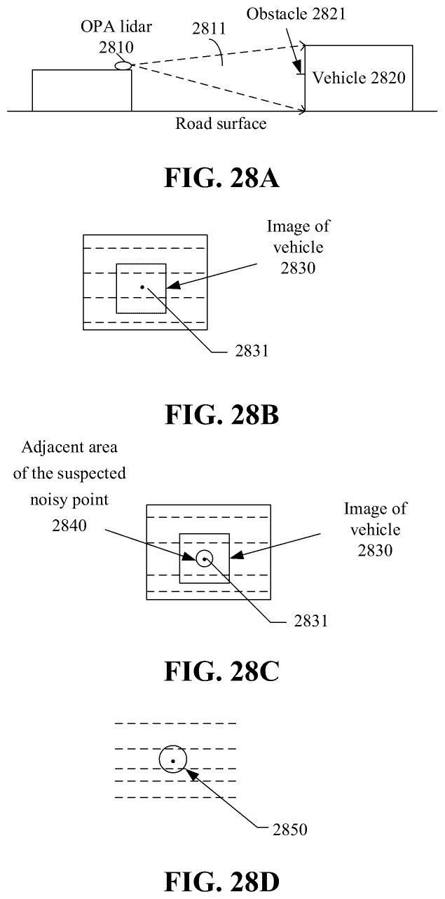

FIGS. 28A-28D illustrate diagrams of another exemplary application scenario of the method for identifying noisy points, according to some embodiments of the present disclosure.

Referring to FIGS. 28A-28D, as shown in FIG. 28A, a vehicle 2820 in front is in a scanning area 2811 of an OPA LiDAR 2810, and there is a protrusion 2821 at the rear end of vehicle 2820. FIG. 28B illustrates a first point cloud with a first scanning resolution obtained by scanning scanning area 2811 using OPA LiDAR 2810. As can be seen from FIG. 28B, there is a protruding point at the rear end of the vehicle ahead (i.e., a suspected noisy point 2831) in an image 2830 of vehicle 2820. By adjusting OPA LiDAR 2810 to increase the scanning resolution and adjust the scanning direction, an adjacent area 2840 of the suspected noisy point 2831 (the circular area in FIG. 28C) is rescanned to obtain a second point cloud with a second scanning resolution as shown in FIG. 28D.

As can be seen from FIG. 28D, there is a target 2850 containing contour information in the second point cloud with the second scanning resolution, so it can be determined that the suspected noisy point 2831 is not a noisy point but an actual obstacle.

In some embodiments, method 2600 for identifying noisy points further includes: eliminating point cloud data corresponding to the noisy points from the first point cloud with the first scanning resolution.

If the suspected noisy points are determined to be noisy points, they should be removed from the first point cloud with the first scanning resolution to avoid affecting the actual measurement results.

It can be seen from the above that the method for identifying noisy points of an OPA LiDAR provided in the embodiments of the present disclosure can also adjust the emission angle and direction of the detection light through the phased array control system. When there are noisy points, the emission angle and direction of the scanning detection light are adjusted, the angular resolution is increased and the adjacent area of the suspected noisy points is scanned, thereby whether the suspected noisy points are noisy points or real obstacles is effectively identified, so as to solve the problem that currently a LiDAR cannot effectively identify whether the isolated points in the scanning point cloud are actual obstacles or noisy points caused by the system itself, and improve the measurement accuracy of LiDAR.

Embodiments of the present disclosure also provide a computer-readable storage medium, the computer-readable storage medium stores a computer program, and the steps in each of the aforesaid embodiments of the method can be implemented when the computer program is executed by a processor.

Embodiments of the present disclosure provide a computer program product. When the computer program product is run on a mobile terminal, the steps in each of the aforesaid embodiments of the method can be implemented when the mobile terminal is executed. The embodiments may further be described using the following clauses:
1. A target detection method based on laser scanning, comprising:
scanning a preset scanning area with a first scanning resolution, to obtain a first point cloud of a first scanning cycle;
performing target detection on the first point cloud of the first scanning cycle;
when a target is detected, determining a fine scanning area and an observation scanning area based on the target, the fine scanning area corresponding to a position of the target in the preset scanning area, and the observation scanning area being an area in the preset scanning area except the fine scanning area; and
scanning the fine scanning area with a second scanning resolution and scanning the observation scanning area with a third scanning resolution, to obtain a second point cloud in a second scanning cycle; wherein the second scanning resolution is greater than the first scanning resolution, and the third scanning resolution is less than or equal to the first scanning resolution.
2. The method according to clause 1, wherein when there are multiple targets, the fine scanning area is an area corresponding to multiple positions of the multiple targets in the preset scanning area.
3. The method according to clause 1, further comprising:
performing target detection on the second point cloud to obtain a second detection result of the target.
4. The method according to clause 3, further comprising:
if a new target exists in the second detection result of the second point cloud, taking the new target as the target; and
updating the fine scanning area and the observation scanning area based on the target.
5. The method according to clause 4, further comprising:
if no new target exists in the second detection result of the second point cloud, scanning the preset scanning area with the first scanning resolution in at least one scanning cycle until the target is detected.
6. The method according to clause 1, wherein scanning the fine scanning area with the second scanning resolution and scanning the observation scanning area with the third scanning resolution, to obtain the second point cloud further comprises:
reducing a frame rate to obtain the second scanning resolution, and scanning the fine scanning area with the second scanning resolution;
increasing the frame rate to obtain the third scanning resolution, and scanning the observation scanning area with the third scanning resolution; and
obtaining the second point cloud.
7. The method according to clause 1, wherein after performing the target detection on the first point cloud of the first scanning cycle, the method further comprises:
if no target is detected in a first detection result of the first point cloud, in a second scanning cycle, scanning the preset scanning area with the first scanning resolution to obtain a corresponding updated first point cloud, until a target is detected in the first detection result of the first point cloud.
8. A target detection device based on laser scanning, comprising:
a laser scanning module configured to scan a preset scanning area with a first scanning resolution to obtain a first point cloud of a first scanning cycle; and
a detection module configured to perform target detection on the first point cloud of the first scanning cycle, and determine a fine scanning area and an observation scanning area based on the target if a target is detected, the fine scanning area corresponding to a position of the target in the preset scanning area and the observation scanning area being an area in the preset scanning area except the fine scanning area;
the laser scanning module is further configured to scan the fine scanning area with a second scanning resolution and scan the observation scanning area with a third scanning resolution, to obtain a second point cloud in a second scanning cycle, wherein the second scanning resolution is greater than the first scanning resolution, and the third scanning resolution is less than or equal to the first scanning resolution.
9. A terminal for target detection, the terminal comprising:
   a memory configured to store instructions; and
   one or more processors configured to execute the instructions to cause the terminal to perform the target detection method according any one of clauses 1 to 7.
10. A target detection method based on laser scanning, comprising:
scanning a preset scanning area with a first scanning resolution to obtain a first point cloud;
performing target detection on the first point cloud;
when a target is detected, determining a fine scanning area and an observation scanning area based on the target, the fine scanning area corresponding to a position of the target in the preset scanning area and the observation scanning area being an area in the preset scanning area except the fine scanning area; and
scanning the fine scanning area with a second scanning resolution and scanning the observation scanning area with a third scanning resolution, to obtain a second point cloud;
wherein a number of point clouds per unit area in the fine scanning area when scanning with the second scanning resolution is larger than a number of point clouds per unit area in the preset scanning area when scanning with the first scanning resolution, a number of point clouds per unit area in the observation scanning area when scanning with the third scanning resolution is smaller than the number of point clouds per unit area in the preset scanning area when scanning with the first scanning resolution.
11. The method according to clause 10, wherein the fine scanning area is a corresponding area of each target in the preset scanning area.
12. The method according to clause 10, further comprising:
determining whether a state of the target changes according to the second point cloud, the state of the target comprising at least one of a number, a speed, an angle, or a distance of the target; and
when the state of the target changes, updating the fine scanning area and the observation scanning area based on the target determined with the second point cloud.
13. The method according to clause 12, further comprising:
when the distance of the target is greater than or equal to a set safety distance, reducing a frame rate, increasing a scanning resolution of the fine scanning area, and reducing a scanning resolution of the observation scanning area; and
when the distance of the target is less than the set safety distance, and the speed of the target which is gradually approaching is greater than a preset speed, increasing the frame rate, increasing the scanning resolution of the fine scanning area, and reducing the scanning resolution of the observation scanning area.
14. A target detection device based on laser scanning, comprising:
an area scanning module configured to scan a preset scanning area with a first scanning resolution to obtain a first point cloud; and
an area dividing module y configured to perform target detection on the first point cloud, and determine a fine scanning area and an observation scanning area based on a target when the target is detected, the fine scanning area corresponding to a position of the target in the preset scanning area and the observation scanning area being an area in the preset scanning area except the fine scanning area;
the area scanning module is further configured to scan the fine scanning area with a second scanning resolution and scan the observation scanning area with a third scanning resolution, to obtain a second point cloud, wherein a number of point clouds per unit area in the fine scanning area when scanning with the second scanning resolution is larger than a number of point clouds per unit area in the preset scanning area when scanning with the first scanning resolution, a number of point clouds per unit area in the observation scanning area when scanning with the third scanning resolution is smaller than the number of point clouds per unit area in the preset scanning area when scanning with the first scanning resolution.
15. A terminal for target detection, the terminal comprising:
   a memory configured to store instructions; and
   one or more processors configured to execute the instructions to cause the terminal to perform the target detection method according any one of clauses 10 to 13.
16. A sensing method for a sensing system, comprising:
obtaining a driving signal and determining a safe driving state based on the driving signal;
adjusting a scanning mode of a sensor in the sensing system according to the safe driving state; and
performing environment scanning according to the scanning mode.
17. The sensing method for sensing system according to clause 16, wherein determining the safe driving state based on the driving signal, comprises:
determining the safe driving state when the driving signal is a signal generated by sensing a change in a target within a preset area; and
adjusting the scanning mode of the sensor in the sensing system according to the safe driving state comprises:
determining the change type of the target according to the safe driving state; and
adjusting a frame rate of the sensor in the sensing system according to the change type.
18. The sensing method for sensing system according to clause 17, wherein if the change type is an existence of a new target, adjusting the frame rate of the sensor in the sensing system according to the change type for scanning, comprises:
reducing the frame rate of the sensor in the sensing system according to the change type to scan the new target.
19. The sensing method for sensing system according to clause 18, wherein reducing the frame rate to scan the new target, comprises:
reducing the frame rate to obtain a reduced frame rate; and
scanning an adjacent area of the new target with reduced frame rate.
20. The sensing method for sensing system according to clause 19, further comprising: scanning other areas with a first frame rate; wherein the other areas are areas in the preset area other than the adjacent area of the new target, and the first frame rate is the frame rate before adjustment.
21. The sensing method for sensing system according to clause 17, wherein if the change type is a change in a motion state of the target or the target being a special target, adjusting the frame rate of the sensor in the sensing system according to the change type for scanning, comprises:
increasing the frame rate according to the change type and detecting the detected target.
22. The sensing method for sensing system according to clause 21, wherein when the target is a vehicle a road scenario, the change in the motion state of the detected target comprises:
when distance information of the vehicle is detected to be less than a first preset distance threshold, and speed information of the vehicle is greater than or equal to a preset speed threshold.
23. The sensing method for sensing system according to clause 17, further comprising:
increasing the frame rate to detect the target when distance information of the target is less than a second preset distance threshold.
24. The sensing method for sensing system according to clause 17, further comprising: adjusting a scanning direction and scanning angle of the sensor in the sensing system according to the change type if the change type is a change in a motion state of the target.
25. A sensing system, comprising:
a state determination module configured to obtain a driving signal and determine a safe driving state based on the driving signal; and
a scanning module configured to adjust a scanning mode of a sensor in the sensing system according to the safe driving state to perform environment scanning according to the scanning mode.
26. The sensing system according to clause 25, further comprising:
a controller; and
a sensor coupled to the controller, wherein the sensor includes at least one of a Light Detection and Ranging (LiDAR), a camera, and a millimeter-wave radar.
27. A terminal comprising:
   a memory configured to store instructions; and
   one or more processors configured to execute the instructions to cause the terminal to perform the sensing method according to any one of clauses 16 to 24.
28. A method for controlling an Optical Phased Array (OPA) Light Detection and Ranging (LiDAR), comprising:
generating a frame rate adjustment instruction when it is determined that LiDAR frame rate adjustment is required; and
adjusting a scanning resolution of the OPA LiDAR by adjusting an amplitude or a frequency of an input voltage of the OPA LiDAR according to the frame rate adjustment instruction.
29. The method for controlling an OPA LiDAR according to clause 28, further comprising:
obtaining a current moment, a number of scans and a current sensing scenario; and
determining whether the LiDAR frame rate adjustment is required based on at least one of the current moment, the number of scans, and the current sensing scenario.
30. The method for controlling an OPA LiDAR according to clause 28, further comprising:
increasing the frame rate by reducing the amplitude or the frequency according to the frame rate adjustment instruction.
31. The method for controlling an OPA LiDAR according to clause 28, further comprising:
increasing the frame rate by reducing the amplitude or the frequency by a preset value according to the frame rate adjustment instruction when the frame rate adjustment instruction complies with a preset instruction.
32. A control system of an Optical Phased Array (OPA) Light Detection and Ranging (LiDAR), comprising:
an instruction generation module configured to generate a frame rate adjustment instruction when it is determined that LiDAR frame rate adjustment is required; and
a resolution adjustment module configured to adjust, according to the frame rate adjustment instruction, an amplitude or a frequency of an input voltage of the OPA LiDAR to adjust a scanning resolution of the OPA LiDAR.
33. A terminal comprising:
a memory configured to store instructions; and
one or more processors configured to execute the instructions to cause the terminal to perform method for controlling an Optical Phased Array (OPA) Light Detection and Ranging (LiDAR) according any one of clauses 28 to 31.
34. A target detection method, applied to an Optical Phased Array (OPA) Light Detection and Ranging (LiDAR) a plurality of phase modulators and a phased array antenna, the phased array antenna comprising multiple antenna sub-arrays, and the plurality of phase modulators are coupled to antennas in the antenna sub-arrays, comprising:
adjusting input light, using the plurality of phase modulators, to the antennas, light emitted by each antenna sub-array forming a light spot at a preset position;
obtaining a light spot combination by combining multiple light spots formed by the light emitted by all antenna sub-arrays according to a preset rule; and
performing target detection based on the light spot combination.
35. The method according to clause 34, further comprising:
determining a number of antennas in each antenna sub-array based on a preset size of the light spot.
36. The method according to clause 34, wherein adjusting the input light using the plurality of phase modulators comprises:
determining a phase of an input light in each antenna based on a preset light emission angle; and
correspondingly adjusting the phase of the light input, using the plurality of phase modulators, into each antenna.
37. The method according to clause 24, further comprising:
determining a number of antennas in each antenna sub-array and a phase of a light input to each antenna according to a preset pattern of light spot combination.
38. The method according to clause 37, wherein numbers of antennas in various antenna sub-arrays are different.
39. The method according to clause 38, wherein a light spot corresponding to the antenna sub-array containing a smallest number of antennas overlaps with light spots corresponding to other antenna sub-arrays.
40. The method according to clause 39, wherein the light spots corresponding to other antenna sub-arrays do not overlap.
41. The method according to clause 38, wherein a first light spot corresponding to an antenna sub-array with a first number of antennas is adjacent to a second light spot corresponding to an antenna sub-array with a second number of antennas; or the first light spot corresponding to an antenna sub-array with the first number of antennas overlaps with the second light spot corresponding to an antenna sub-array with the second number of antennas.
42. The method according to clause 38, wherein a first light spot corresponding to the antenna sub-array with a first number of antennas is located in a middle position, and a second light spot corresponding to the antenna sub-arrays with a second number of antennas are located at both sides.
43. The method according to clause 37, wherein before determining the number of antennas in various antenna sub-arrays, the method further comprises:
determining whether to divide the phased array antenna into antenna sub-arrays.
44. A Light Detection and Ranging (LiDAR), comprising: a memory configured to store instructions; and
one or more processors configured to execute the instructions to cause the LiDAR to perform the target detection method according to any one of clauses 34 to 43.
45. A target detection method, applied to an Optical Phased Array (OPA) Light Detection and Ranging (LiDAR) comprising a plurality of phase modulators and a phased array antenna, and the plurality of phase modulators coupled to a plurality of antennas in the phased array antenna, comprising:
scanning a preset area to obtain a reflection signal of a first frame, the reflection signal of the first frame being obtained by detecting light reflected by the preset area;
dividing the phased array antenna based on the reflection signal of the first frame to obtain multiple antenna sub-arrays;
adjusting light input, using the plurality of phase modulators, to the plurality of antennas, the light emitted by each antenna sub-array forming a light spot at a preset position;
obtaining a light spot combination by combining multiple light spots formed all antenna sub-arrays according to a preset rule; and
performing target detection based on the light spot combination.
46. The method according to clause 45, wherein dividing the phased array antenna based on the reflection signal of the first frame to obtain multiple antenna sub-arrays; and adjust the input light using the phase modulators, the light emitted by each antenna sub-array forming a light spot at a preset position, comprise:
determining an arrangement and combination of the light spots corresponding to each antenna sub-array based on target information corresponding to the reflected signal of the first frame, and the arrangement and combination includes a number and a relative position arrangement of the light spots;
dividing the phased array antenna based on the arrangement and combination of light spots to determine multiple antenna sub-arrays and a phase difference corresponding to each antenna sub-array; and
adjusting the input light using the plurality of phase modulators based on the phase difference corresponding to each antenna sub-array, the light emitted by each antenna sub-array forming a light spot at a preset position.
47. A Light Detection and Ranging (LiDAR), comprising: a memory configured to store instructions; and
one or more processors configured to execute the instructions to cause the LiDAR to perform the target detection method according to clauses 45 or 46.
48. A target detection method, applied to an Optical Phased Array (OPA) Light Detection and Ranging (LiDAR), comprising a plurality of phase modulators and a phased array antenna, the plurality of phase modulators coupled to a plurality of antennas in the phased array antenna, comprising:
scanning a preset area to determine scenario information;
determining adjustment information of a preset light spot according to the scenario information;
dividing the phased array antenna based on the adjustment information to obtain multiple antenna sub-arrays; and adjusting light input, using the plurality of phase modulators, to the plurality of antennas, light emitted by each antenna sub-array forming a light spot at a preset position, and multiple light spots formed all antenna sub-arrays being combined according to a preset rule to obtain a light spot combination; and
performing target detection based on the light spot combination.
49. The method according to clause 48, wherein determining the adjustment information of the preset light spot according to the scenario information comprises:
when the scenario information is a scenario of long-distance detection, the adjustment information is determined to increase the light spot.
50. The method according to clause 49, wherein determining the scenario information comprises:
when it is determined that the target cannot be detected based on reflected light corresponding to the preset area, the scenario information is determined to be the scenario of long-distance detection.
51. The method according to clause 48, wherein determining the adjustment information of the preset light spot according to the scenario information comprises:
when the scenario information is a scenario of specular reflection, the adjustment information is determined to increase the light spot.
52. The method according to clause 51, wherein determining the scenario information comprises:
when it is determined based on the reflected light corresponding to the preset area that an intensity difference of the reflected signals in different frames is greater than a preset difference, the scenario information is determined to be a scenario of specular reflection.
53. The method according to clause 48, wherein determining the adjustment information of the preset light spot according to the scenario information comprises:
when the scenario information is a scenario of small target, the adjustment information is determined to increase the light spot.
54. The method according to clause 53, wherein determining the scenario information comprises:
when it is determined based on reflected light corresponding to the preset area that there are light spots that cannot hit the target, the scenario information is determined to be the scenario of small target.
55. A Light Detection and Ranging (LiDAR), comprising: a memory configured to store instructions; and
one or more processors configured to execute the instructions to cause the LiDAR to perform the target detection method according to any one of clauses 48 to 54.
56. A method for identifying noisy points of an Optical Phased Array (OPA) Light Detection and Ranging (LiDAR), comprising:
scanning a scanning area with a first scanning resolution to obtain a first point cloud;
performing target detection on the first point cloud and identifying suspected noisy points;
increasing an angular resolution to obtain a second scanning resolution and scanning an adjacent area of the suspected noisy points in the scanning area with the second scanning resolution to obtain a second point cloud; and
determining whether the suspected noisy points are noisy points according to the second point cloud.
57. The method according to clause 56, wherein determining whether the suspected noisy points are noisy points according to the second point cloud comprises:
performing the target detection on the second point cloud with the second scanning resolution;
when a detection result of target detection contains contour information, determining that the suspected noisy points are non-noisy points; and
when the detection result of target detection does not contain contour information, determining that the suspected noisy points are noisy points.
58. The method according to clause 57, wherein when the detection result of target detection does not contain contour information, determining that the suspected noisy points are noisy points further comprises:
when the detection result of the target detection indicates that no target is detected, determining that the suspected noisy points are noisy points.
59. The method for identifying noisy points according to clause 56, wherein increasing the angular resolution to obtain the second scanning resolution and scanning the adjacent area of the suspected noisy points in the scanning area with the second scanning resolution to obtain the second point cloud comprises:
determining the adjacent area of suspected noisy points;
increasing the angular resolution to obtaining the second scanning resolution; and
adjusting a scanning direction to scan the adjacent area of the suspected noisy points with the second scanning resolution to obtain a second point cloud.
60. The method for identifying noisy points according to clause 56, further comprising:
eliminating point cloud data corresponding to the noisy points from the first point cloud.
61. The method for identifying noisy points according to clause 56, wherein performing target detection on the first point cloud and identifying suspected noisy points comprises:
determining whether there is an isolated point by detecting the first point cloud with the first scanning resolution; and
if there is the isolated point, identifying the isolated point as a suspected noisy point.
62. The method for identifying noisy points according to clause 59, wherein determining the adjacent area of suspected noisy points comprises:
determining an adjacent point cloud area of the suspected noisy points as the adjacent area of suspected noisy points.
63. An Optical Phased Array (OPA) Light Detection and Ranging (LiDAR), comprising:
a light source configured to output optical signals;
a beam splitter coupled to the light source and configured to split the optical signals output by the light source;
a phase modulator coupled to the beam splitter and configured to modulate the split optical signals; and
a phased array antenna coupled to the phase modulator, and configured to emit the split optical signals into space as detection light and receive reflected echoes in space, wherein the detection light can form a scanning light spot in space;
a phased array control system coupled to the phase modulator and configured to adjust an emission angle and emission direction of the detection light to adjust a formation position of the scanning light spot;
a signal processing system coupled to the phased array antenna and configured to process reflected echoes and obtain corresponding electrical signals; and
a main control system coupled to the phased array control system and the signal processing system respectively and configured to:
   calculate a distance and speed of a target object in a scanning area based on electrical signals; and
   send feedback adjustment instructions to the phased array control system when there are suspected noisy points in the scanning area to adjust the emission angle and direction of the detection light, increase an angular resolution, and scan an adjacent area of suspected noisy points.
64. The OPA LiDAR according to clause 63, wherein if the optical signals have a frequency modulated continuous wave, the OPA LiDAR further comprises:
a frequency mixer coupled to the beam splitter and the phased array antenna respectively, and configured to mix the reflected echoes and reference light to obtain difference frequency optical signals, the difference frequency optical signals being used to calculate a distance and speed.
65. The OPA LiDAR according to clause 63, further comprising
a host computer communicatively coupled with the main control system and configured to form a first point cloud with a first scanning resolution and a second point cloud with a second scanning resolution based on the distance and speed.
66. The OPA LiDAR according to clause 65, wherein the host computer is further configured to determine whether suspected noisy points are noisy points based on the second point cloud with the second scanning resolution.
67. The OPA LiDAR according to clause 63, wherein the light source includes a semiconductor light source.
68. The OPA LiDAR according to clause 63, wherein processing the reflected echoes includes photoelectric detection, signal filtering, amplification and collection of the reflected echoes.
69. The OPA LiDAR according to clause 64, wherein the signal processing system is coupled to the frequency mixer and is configured to process the difference frequency optical signals output by the frequency mixer to obtain electrical signals corresponding to the difference frequency optical signals.
70. A non-transitory computer readable medium that stores a set of instructions that is executable by one or more processors of an apparatus to cause the apparatus to perform the method for identifying noisy points of an Optical Phased Array (OPA) Light Detection and Ranging (LiDAR), according any one of clauses 56 to 62.
71. A non-transitory computer readable medium that stores a set of instructions that is executable by one or more processors of an apparatus to cause the apparatus to perform the target detection method according to any one of clauses 1 to 7.
72. A non-transitory computer readable medium that stores a set of instructions that is executable by one or more processors of an apparatus to cause the apparatus to perform the target detection method according any one of clauses 10 to 13.
73. A non-transitory computer readable medium that stores a set of instructions that is executable by one or more processors of an apparatus to cause the apparatus to perform the sensing method according any one of clauses 16 to 24.
74. A non-transitory computer readable medium that stores a set of instructions that is executable by one or more processors of an apparatus to cause the apparatus to perform method for controlling an Optical Phased Array (OPA) Light Detection and Ranging (LiDAR) according any one of clauses 28 to 31.
75. A non-transitory computer readable medium that stores a set of instructions that is executable by one or more processors of an apparatus to cause the apparatus to perform method for target detection according any one of clauses 34 to 43.
76. A non-transitory computer readable medium that stores a set of instructions that is executable by one or more processors of an apparatus to cause the apparatus to perform method for target detection according to clause 45 or 46.
77. A non-transitory computer readable medium that stores a set of instructions that is executable by one or more processors of an apparatus to cause the apparatus to perform method for target detection according any one of clauses 48 to 54.

In some embodiments, a non-transitory computer-readable storage medium including instructions is also provided, and the instructions may be executed by a device, for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A target detection method based on laser scanning, comprising:
scanning a preset scanning area with a first scanning resolution to obtain a first point cloud in a first scanning cycle;
performing target detection on the first point cloud;
when a target is detected, determining a fine scanning area and an observation scanning area based on the target, the fine scanning area corresponding to a position of the target in the preset scanning area, and the observation scanning area being an area in the preset scanning area except the fine scanning area; and
scanning the fine scanning area with a second scanning resolution and scanning the observation scanning area with a third scanning resolution, to obtain a second point cloud in a second scanning cycle; wherein the second scanning resolution is greater than the first scanning resolution, and the third scanning resolution is less than or equal to the first scanning resolution.

2. The method according to claim 1, wherein when there are multiple targets, the fine scanning area is an area corresponding to multiple positions of the multiple targets in the preset scanning area.

3. The method according to claim 1, further comprising:
performing target detection on the second point cloud to obtain a second detection result of the target.

4. The method according to claim 3, further comprising:
if a new target exists in the second detection result of the second point cloud, determining the new target as the target; and
updating the fine scanning area and the observation scanning area based on the target.

5. The method according to claim 4, further comprising:
if no new target exists in the second detection result of the second point cloud, scanning the preset scanning area with the first scanning resolution in at least one scanning cycle until the target is detected.

6. The method according to claim 1, wherein scanning the fine scanning area with the second scanning resolution and scanning the observation scanning area with the third scanning resolution, to obtain the second point cloud further comprises:
reducing a frame rate to obtain the second scanning resolution, and increasing the frame rate to obtain the third scanning resolution; and
scanning the fine scanning area with the second scanning resolution and scanning the observation scanning area with the third scanning resolution, to obtain the second point cloud.

7. The method according to claim 1, wherein after performing the target detection on the first point cloud of the first scanning cycle, the method further comprises:
if no target is detected in a first detection result of the first point cloud, scanning the preset scanning area with the first scanning resolution to obtain a corresponding updated first point cloud, until a target is detected in the first detection result of the first point cloud.

8. A target detection method based on laser scanning, comprising:
scanning a preset scanning area with a first scanning resolution to obtain a first point cloud;
performing target detection on the first point cloud;
when a target is detected, determining a fine scanning area and an observation scanning area based on the target, the fine scanning area corresponding to a position of the target in the preset scanning area and the observation scanning area being an area in the preset scanning area except the fine scanning area; and
scanning the fine scanning area with a second scanning resolution and scanning the observation scanning area with a third scanning resolution, to obtain a second point cloud;
wherein a number of point clouds per unit area in the fine scanning area when scanning with the second scanning resolution is larger than a number of point clouds per unit area in the preset scanning area when scanning with the first scanning resolution, and a number of point clouds per unit area in the observation scanning area when scanning with the third scanning resolution is smaller than the number of point clouds per unit area in the preset scanning area when scanning with the first scanning resolution.

9. The method according to claim 8, wherein the fine scanning area comprises a corresponding area of each target in the preset scanning area.

10. The method according to claim 8, further comprising:
determining whether a state of the target changes according to the second point cloud, the state of the target comprising at least one of a number, a speed, an azimuth angle, or a distance of the target; and
when the state of the target changes, updating the fine scanning area and the observation scanning area based on the target determined in the second point cloud.

11. The method according to claim 10, further comprising:
when the distance of the target is greater than or equal to a set safety distance, reducing a frame rate, increasing a scanning resolution of the fine scanning area, and reducing a scanning resolution of the observation scanning area; and
when the distance of the target is less than the set safety distance, and the speed of the target which is gradually approaching is greater than a preset speed, increasing the frame rate, increasing the scanning resolution of the fine scanning area, and reducing the scanning resolution of the observation scanning area.

12. A target detection device based on laser scanning, comprising:
a laser scanning module configured to scan a preset scanning area with a first scanning resolution to obtain a first point cloud of a first scanning cycle; and
a detection module configured to perform target detection on the first point cloud of the first scanning cycle, and determine a fine scanning area and an observation scanning area based on a target when the target is detected, the fine scanning area corresponding to a position of the target in the preset scanning area and the observation scanning area being an area in the preset scanning area except the fine scanning area;
the laser scanning module is further configured to scan the fine scanning area with a second scanning resolution and scan the observation scanning area with a third scanning resolution, to obtain a second point cloud in a second scanning cycle, wherein the second scanning resolution is greater than the first scanning resolution, and the third scanning resolution is less than or equal to the first scanning resolution.

13. The target detection device according to claim 12, wherein when there are multiple targets, the fine scanning area is an area corresponding to multiple positions of the multiple targets in the preset scanning area.

14. The target detection device according to claim 12, wherein the detection module is further configured to perform target detection on the second point cloud to obtain a second detection result of the target.

15. The target detection device according to claim 14, wherein the detection module is further configured to:
if a new target exists in the second detection result of the second point cloud, determine the new target as the target, and update the fine scanning area and the observation scanning area based on the target in the second point cloud; and
if no new target exists in the second detection result of the second point cloud, scan the preset scanning area with the first scanning resolution in at least one scanning cycle until the target is detected.

16. The target detection device according to claim 12, wherein the laser scanning module is further configured to:
reduce a frame rate to obtain the second scanning resolution, and scan the fine scanning area with the second scanning resolution;
increase the frame rate to obtain the third scanning resolution, and scan the observation scanning area with the third scanning resolution; and
obtain the second point cloud.

17. A target detection device based on laser scanning, comprising:
an area scanning module configured to scan a preset scanning area with a first scanning resolution to obtain a first point cloud; and
an area dividing module configured to perform target detection on the first point cloud, and determine a fine scanning area and an observation scanning area based on a target when the target is detected, the fine scanning area corresponding to a position of the target in the preset scanning area and the observation scanning area being an area in the preset scanning area except the fine scanning area;
the area scanning module is further configured to scan the fine scanning area with a second scanning resolution and scan the observation scanning area with a third scanning resolution, to obtain a second point cloud, wherein a number of point clouds per unit area in the fine scanning area when scanning with the second scanning resolution is larger than a number of point clouds per unit area in the preset scanning area when scanning with the first scanning resolution, and a number of point clouds per unit area in the observation scanning area when scanning with the third scanning resolution is smaller than the number of point clouds per unit area in the preset scanning area when scanning with the first scanning resolution.

18. The target detection device according to claim 17, wherein the area dividing module is further configured to:
determine whether a state of the target changes according to the second point cloud, wherein the state of the target comprise at least one of a number, a speed, an azimuth angle, and a distance of the target; and
update the fine scanning area and the observation scanning area based on the target determined in the second point cloud when the state of the target changes.

19. The target detection device according to claim 17, when a distance of the target is greater than or equal to a set safety distance, the area scanning module is further configured to reduce a frame rate, increase a scanning resolution of the fine scanning area, and reduce a scanning resolution of the observation scanning area; and
when the distance of the target is less than the set safety distance, and a speed of the target which is gradually approaching is greater than a preset speed, the area scanning module is further configured to increase the frame rate, reduce the scanning resolution of the fine scanning area, and reduce the scanning resolution of the observation scanning area.

20. The target detection device according to claim 17, wherein the fine scanning area comprises a corresponding area of each target in the preset scanning area.
